(19) United States
(12) Patent Application Publication
(10) Pub. No.: US 2020/0312553 A1
(43) Pub. Date: Oct. 1, 2020

(54) DIELECTRIC FILM, DIELECTRIC THIN FILM, ELECTRONIC COMPONENT, THIN FILM CAPACITOR, AND ELECTRONIC CIRCUIT BOARD

(71) Applicant: TDK Corporation, Tokyo (JP)

(72) Inventors: Shirou OOTSUKI, Tokyo (JP); Aiko TAKAHASHI, Tokyo (JP); Yasunori HARADA, Tokyo (JP); Shota SUZUKI, Tokyo (JP); Yasunaga KAGAYA, Tokyo (JP); Tomohiko KATO, Tokyo (JP); Mirai ISHIDA, Tokyo (JP)

(73) Assignee: TDK Corporation, Tokyo (JP)

(21) Appl. No.: 16/823,789

(22) Filed: Mar. 19, 2020

(30) Foreign Application Priority Data
Mar. 25, 2019 (JP) 2019-057053
Mar. 25, 2019 (JP) 2019-057061
Mar. 25, 2019 (JP) 2019-057109
Sep. 30, 2019 (JP) 2019-178848
Sep. 30, 2019 (JP) 2019-179991
Sep. 30, 2019 (JP) 2019-180004

(51) Int. Cl. H01G 4/10; H01G 4/14

(52) U.S. Cl. CPC H01G 4/10; H01G 4/14

(57) ABSTRACT

A dielectric film, contains: (1) Bi and Ti; (2) at least one element E1 selected from the group consisting of Na and K; and (3) at least one element E2 selected from the group consisting of Ba, Sr, and Ca. The dielectric film has a main phase containing an oxide that contains Bi, Ti, the element E1, and the element E2 and has a perovskite structure, and a subphase that contains Bi and has an oxygen concentration lower than that of the main phase. In a sectional surface of the dielectric film, a ratio RS of an area of the subphase to a sum of an area of the main phase and the area of the subphase is greater than or equal to 0.03 and less than or equal to 0.3.

### TECHNICAL FIELD

The present invention relates to a dielectric film, a dielectric thin film, an electronic component, a thin film capacitor, and an electronic circuit board.

### BACKGROUND

A space in which an electronic component is contained in an electronic device has become narrower in accordance with the recent downsizing of the electronic device. Therefore, a small and thin electronic component is required. A thin film capacitor is one type of electronic component that is mounted on various electronic devices (refer to Japanese Unexamined Patent Publication No. 2000-49045, the pamphlet of International Publication No. 2017/012800, and Japanese Unexamined Patent Publication No. 2006-160594). In Japan, the thin film capacitor is generally referred to as a thin film condenser. A substrate, an insulating film, an electrode, and a dielectric thin film provided in the thin film capacitor are thin compared to members configuring a laminated ceramic capacitor of the related art, and the thickness of the entire thin film capacitor is also thin compared to the laminated ceramic capacitor of the related art. Therefore, it has been expected that a thin film capacitor is mounted on a small electronic device, instead of the laminated ceramic capacitor of the related art. Recently, a thin film capacitor embedded in an electronic circuit board has been also developed.

### SUMMARY

### First Invention

It is general that an electric capacitance of the thin film capacitor is smaller than that of the laminated ceramic capacitor of the related art. Examples of one method of improving the electric capacitance include a method of decreasing a film thickness of a dielectric film. However, in a case where the film thickness of the dielectric film is decreased, in actual use, a direct-current electric field intensity to be applied to a dielectric substance increases even in a case where direct voltages to be applied to both ends of the dielectric film are the same. Then, a relative permittivity of a ferroelectric substance such as BaTiO₃ has so-called DC bias properties that the relative permittivity decreases as the direct-current electric field intensity increases, and thus, it is not possible to improve the electric capacitance even in a case where the film thickness is small.

In addition, it is also required that a change amount of the relative permittivity (the capacitance) according to a temperature change is small from the viewpoint of stabilizing the electrostatic capacitance of the dielectric film. In other words, it is required that temperature properties of the relative permittivity are improved from the viewpoint of stabilizing the electrostatic capacitance of the dielectric film.

In Japanese Unexamined Patent Publication No. 2000-49045, it is disclosed that a tungsten bronze type composite oxide containing K, Sr, Mg, and Nb is used in the dielectric film, and thus, the DC bias properties are improved.

In International Publication No. 2017/012800, a perovskite-like dielectric substance having a core-shell structure is disclosed and it is disclosed that the DC bias properties are improved.

In Japanese Unexamined Patent Publication No. 2006-160594, X5R properties of an ETA standard, that is, a finding that a capacitance change rate in a range of −55° C. to 85° C. is within ±15% by adding Si, Mg, Y, and the like to barium titanate is obtained.

However, in each of the inventions described in Japanese Unexamined Patent Publication No. 2000-49045, the pamphlet of International Publication No. 2017/012800, and Japanese Unexamined Patent Publication No. 2006-160594, it is not possible to make the improvement of the DC bias properties and the improvement of the temperature properties of the relative permittivity compatible.

The first invention has been made in order to solve the problems described above, and an object thereof is to provide a dielectric film, an electronic component, a thin film capacitor, and an electronic circuit board in which it is possible to improve both of the DC bias properties and the temperature properties of the relative permittivity.

A dielectric film according to one aspect of the first invention is a dielectric film containing: (1) Bi and Ti; (2) at least one element E1 selected from the group consisting of Na and K; and (3) at least one element E2 selected from the group consisting of Ba, Sr, and Ca. The dielectric film has a main phase containing an oxide that contains Bi, Ti, the element E1, and the element E2 and has a perovskite structure, and a subphase that contains Bi and has an oxygen concentration lower than that of the main phase. Further, in a sectional surface of the dielectric film, a ratio RS of an area of the subphase to a sum of an area of the main phase and the area of the subphase satisfies the following expression.

0.03≤RS≤0.3

Here, Total Number of Atoms of Bi and Element E1:Total Number of Atoms of Element E2 can be 30:70 to 90:10.

In addition, in the oxide, a ratio of the number of atoms of the element E1 to the number of atoms of Bi can be 0.9 to 1.1.

In addition, in the oxide, a ratio of the number of atoms of Ti to the total number of atoms of Bi, the element E1, and the element E2 can be 0.9 to 1.1.

An electronic component according to one aspect of the first invention includes the dielectric film described above.

Here, the electronic component is capable of further including an electrode, and the dielectric film may be in contact with the electrode.

A thin film capacitor according to one aspect of the first invention comprises the dielectric film described above.

An electronic circuit board according to one aspect of the first invention comprises the dielectric film described above.

An electronic circuit board according to one aspect of the first invention comprises the electronic component described above.

An electronic circuit board according to one aspect of the first invention comprises the thin film capacitor described above.

According to the first invention, the dielectric film or the like are provided in which it is possible to improve both of the DC bias properties and the temperature properties of the relative permittivity.

### Second Invention

The electronic device on which the thin film capacitor is mounted is used in various environments. However, the relative permittivity of the dielectric thin film of the related art is easily changed in accordance with a temperature change. Therefore, in order for the electronic device to be stably operated in various environments, it is required that a change in the relative permittivity according to the temperature change is small. The temperature properties described below are properties that the relative permittivity is less likely to be changed in accordance with the temperature change.

For example, in Japanese Unexamined Patent Publication No. 2006-160594, it is disclosed that in order to improve the temperature properties, dielectric ceramics contain at least one type selected from the group consisting of Si, Mg, Mn, Y, and Ca. In the laminated ceramic capacitor containing the dielectric ceramics, X5R based on EIA standard is attained. X5R indicates performance that a change rate of an electrostatic capacitance of a capacitor is greater than or equal to −15% and less than or equal to 15%, in a temperature range of higher than or equal to −55° C. and lower than or equal to 85° C.

In contrast to the dielectric ceramics described above, the dielectric thin film of the related art is not necessarily excellent in the temperature properties.

An object of the second invention is to provide a dielectric thin film that is excellent in the temperature properties, and an electronic component, a thin film capacitor, and an electronic circuit board, comprising the dielectric thin film.

A dielectric thin film according to one aspect of the second invention contains an oxide having a perovskite structure, wherein the oxide contains Bi, an element E1, an element E2, and Ti, the element E1 is at least one element selected from the group consisting of Na and K, the element E2 is at least one element selected from the group consisting of Ca, Sr, and Ba, and the oxide contains twin crystals (crystal twinning).

A content of Bi in the dielectric thin film may be represented by [Bi] mol %, a sum of contents of the elements E2 in the dielectric thin film may be represented by [E2] mol %, and [Bi][E2] may be greater than or equal to 0.214 and less than or equal to 4.500.

An electronic component according to one aspect of the second invention comprises the dielectric thin film described above.

A thin film capacitor according to one aspect of the second invention comprises the dielectric thin film described above.

An electronic circuit board according to one aspect of the second invention may comprise the dielectric thin film described above.

An electronic circuit board according to one aspect of the second invention may comprise the electronic component described above.

An electronic circuit board according to one aspect of the second invention may comprise the thin film capacitor described above.

According to the second invention, the dielectric thin film that is excellent in the temperature properties, and the electronic component, the thin film capacitor, and the electronic circuit board, including the dielectric thin film, are provided.

### Third Invention

The electronic device on which the thin film capacitor is mounted is used in various environments. However, the relative permittivity of the dielectric thin film of the related art is easily changed in accordance with a temperature change. Therefore, in order for the electronic device to be stably operated in various environments, it is required that a change in the relative permittivity according to the temperature change is small. The temperature properties described below are properties that the relative permittivity is less likely to be changed in accordance with the temperature change.

For example, in Japanese Unexamined Patent Publication No. 2006-160594, it is disclosed that in order to improve the temperature properties, dielectric ceramics contain at least one type selected from the group consisting of Si, Mg, Mn, Y, and Ca. In the laminated ceramic capacitor containing the dielectric ceramics, X5R based on EIA standard is attained. X5R indicates performance that a change rate of an electrostatic capacitance of a capacitor is greater than or equal to −15% and less than or equal to 15%, in a temperature range of higher than or equal to −55° C. and lower than or equal to 85° C.

In contrast to the dielectric ceramics described above, the dielectric thin film of the related art is not necessarily excellent in the temperature properties.

An object of the third invention is to provide a dielectric thin film that is excellent in the temperature properties, and an electronic component, a thin film capacitor, and an electronic circuit board, comprising the dielectric thin film.

A dielectric thin film according to a first aspect of the third invention contains an oxide having a perovskite structure, wherein the oxide contains Bi, an element E1, an element E2, and Ti, the element EL is at least one element selected from the group consisting of Na and K, the element E2 is at least one element selected from the group consisting of Ca, Sr, and Ba, and the dielectric thin film contains tetragonal crystals of the oxide and rhombohedral crystals of the oxide.

A dielectric thin film according to a second aspect of the third invention is a dielectric thin film containing an oxide having a perovskite structure, wherein the oxide contains Bi, an element E1, an element E2, and Ti, the element E1 is at least one element selected from the group consisting of Na and K, the element E2 is at least one element selected from the group consisting of Ca, Sr, and Ba, an X-ray diffraction pattern of the dielectric thin film is measured by using a CuKα ray as an incident X-ray, the X-ray diffraction pattern includes a peak having a diffraction angle 2θ of greater than or equal to 39.0° and less than or equal to 41.2°, the peak having the diffraction angle 2θ of greater than or equal to 39.0° and less than or equal to 41.2° is represented by superposition of a first peak and a second peak, a diffraction angle 2θ₁ of the first peak is less than a diffraction angle 2θ₂ of the second peak, S1 is an area of the first peak, S2 is an area of the second peak, and S1/S2 is greater than or equal to 0.02 and less than or equal to 55.

The dielectric thin film according to the second aspect of the third invention may contain tetragonal crystals of the oxide and rhombohedral crystals of the oxide, wherein the first peak may be derived from the tetragonal crystals of the oxide, and the second peak may be derived from the rhombohedral crystals of the oxide.

In the first aspect and the second aspect of the third invention, a content of Bi in the dielectric thin film may be represented by [Bi] mol %, a sum of contents of the elements E2 in the dielectric thin film may be represented by [E2] mol %, and [Bi]/[E2] may be greater than or equal to 0.214 and less than or equal to 4.500.

An electronic component according to one aspect of the third invention comprises the dielectric thin film described above.

A thin film capacitor according to one aspect of the third invention comprises the dielectric thin film described above.

An electronic circuit board according to one aspect of the third invention may comprise the dielectric thin film described above.

An electronic circuit board according to one aspect of the third invention may comprise the electronic component described above.

An electronic circuit board according to one aspect of the third invention may comprise the thin film capacitor described above.

According to the third invention, the dielectric thin film that is excellent in the temperature properties, and the electronic component, the thin film capacitor, and the electronic circuit board, including the dielectric thin film, are provided.

### BRIEF DESCRIPTION OF THE DRAWINGS

FIG. 1 is a sectional view of a dielectric film according to one embodiment of the first invention.

FIG. 2 is a schematic sectional view of an electronic component (a thin film capacitor) according to an embodiment of each of the first invention, the second invention, and the third invention.

FIG. 3A and FIG. 3B are sectional views of an electronic component according to another embodiment of the first invention.

FIG. 4A is a schematic sectional view of an electronic circuit board according to an embodiment of each of the first invention, the second invention, and the third invention, and FIG. 4B is an enlarged view of a portion 90A illustrated in FIG. 4A.

FIG. 5 is a schematic perspective view of a unit cell of a perovskite structure, and relates to the second invention.

FIG. 6 is a schematic sectional view of twin crystals of an oxide, and relates to the second invention.

FIG. 7 is a schematic view of a fast Fourier transform pattern of an image of the twin crystals of the oxide, which is captured by the transmission electron microscope, and relates to the second invention.

FIG. 8 is a crystal lattice image of a dielectric thin film of Example 31, which is captured by a transmission electron microscope, and relates to the second invention.

FIG. 9A is an FFT pattern of the image shown in FIG. 8, FIG. 9B is an enlarged view of a spot of 211 shown in FIG. 9A, and FIG. 9A and FIG. 9B relate to the second invention.

FIG. 10 is a schematic perspective view of tetragonal crystals of an oxide having a perovskite structure, and relates to the third invention.

FIG. 11 is a schematic perspective view of rhombohedral crystals of the oxide having the perovskite structure, and relates to the third invention.

FIG. 12 is a peak in an X-ray diffraction pattern of Example 51 of the third invention.

FIG. 13 is a first peak and a second peak configuring the peak shown in FIG. 12.

FIG. 14 is a peak that is represented by superposition of the first peak and the second peak shown in FIG. 13.

FIG. 15 is the peak in FIG. 12 and the peak in FIG. 14.

### DETAILED DESCRIPTION

### Embodiments of First Invention

Hereinafter, embodiments of the first invention will be described in detail.

(Dielectric Film)

A dielectric film according to an embodiment of the first invention is a dielectric film, containing:

(1) Bi and Ti;

(2) at least one element E1 selected from the group consisting of Na and K; and

(3) at least one element E2 selected from the group consisting of Ba, Sr, and Ca. The dielectric film has a main phase containing an oxide that contains Bi, Ti, the element E1, and the element E2 and has a perovskite structure, and a subphase that contains Bi and has an oxygen concentration lower than that of the main phase. Further, in a sectional surface of the dielectric film, a ratio RS of an area of the subphase to a sum of an area of the main phase and the area of the subphase satisfies the following expression.

0.03≤RS≤0.3

Here, it is preferable that Total Number of Atoms of Bi and Element E1:Total Number of Atoms of Element E2 is 30:70 to 90:10. Accordingly, a high permittivity is easily exhibited.

In addition, in the oxide, a ratio of the number of atoms of the element E1 to the number of atoms of Bi can be 0.9 to 1.1. The ratio of the number of atoms may be 0.95 to 1.05.

In addition, in the oxide, a ratio of the number of atoms of Ti to the total number of atoms Bi, the element E1, and the element E2 can be 0.9 to 1.1. A lower limit may be 0.95, and an upper limit may be less than or equal to 1.05.

The element E1 may be at least one element selected from the group consisting of Na and K, and for example, may be only Na or only K, or may be a combination of Na and K. In a case where the element E1 includes two types of elements, the ratio is arbitrary.

The element E2 may be at least one of Ba, Sr, and Ca, and for example, may be only Ba, only Sr, or only Ca, may be a combination of Ba and Sr, a combination of Ba and Ca, and a combination of Sr and Ca, and may be a combination of all of Ba, Sr, and Ca. In a case where the element E2 includes two or more types of elements, the ratio is arbitrary.

(Structure of Dielectric Film)

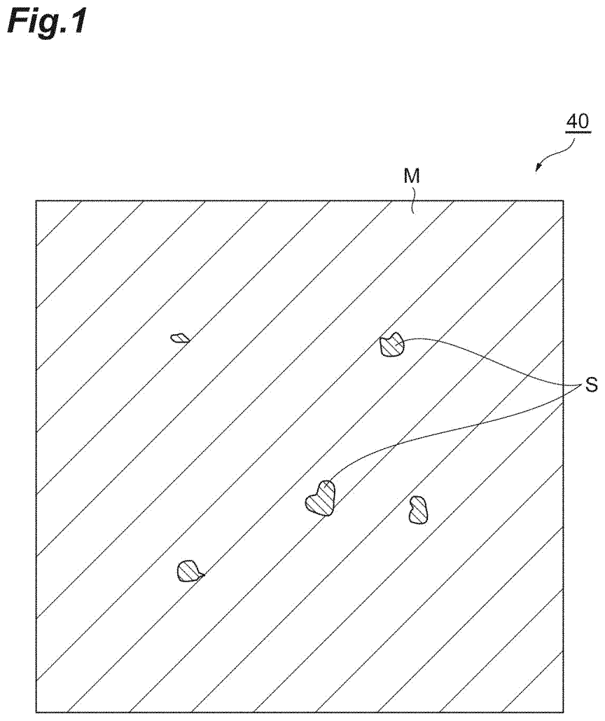

The dielectric film has the main phase and the subphase. FIG. 1 illustrates an example of a sectional surface schematic view of a dielectric film 40. A main phase M forms a continuous phase, and a subphase S is dispersed in the main phase M. In the embodiment of the first invention, in a sectional surface, the subphase S is spatially and homogeneously dispersed.

(Main Phase)

The main phase contains a plurality of oxide crystals that contain Bi, Ti, the element E1, and the element E2 and have the perovskite structure. The content of the oxide crystals in the main phase can be greater than or equal to 90 mass %, can be greater than or equal to 95 mass %, can also be greater than or equal to 99 mass %, and may be 100 mass %.

The perovskite structure is a crystalline structure that is generally represented by ABX₃. A cation on a site A is positioned on the vertex of a hexahedral unit lattice, a cation on a site B is positioned on the body center of the unit lattice, and an anion on a site X is positioned on the face center of the unit lattice. In the first invention, a cation such as Ba²⁺, Ca²⁺, Sr²⁺, Bi³⁺, Na⁺, and K⁺ (a combination of a divalent ion or a monovalent ion and a trivalent ion) enters to the site A, a tetravalent cation such as a Ti⁴⁺ ion enters the site B, and a divalent anion such as an O²⁻ ion enters the site X.

(Subphase)

The subphase S contains Bi and has the oxygen concentration lower than that of the main phase, and is dispersed in the main phase M. The oxygen concentration is a ratio (atm %) of the number of oxygen atoms to all atoms configuring the phase. For example, the oxygen concentration of each phase can be acquired by energy dispersion type X-ray spectrometry (STEM-EDS) of a scanning transmission electron microscope. The oxygen concentration of the main phase M is approximately 50 atom %, and the oxygen concentration of the subphase S is generally less than the oxygen concentration of the main phase M by greater than or equal to 20 atom %. The subphase S may be a metal phase substantially containing oxygen, or may contain oxygen to some extent. In general, such a subphase S does not have a perovskite structure.

The equivalent circle diameter of each of the particles of the subphase S can be 1 nm to 30 nm. The subphase S may contain a metal element other than Bi.

In the embodiment of the first invention, in a sectional surface of the dielectric film 40, a ratio RS of an area of the subphase S to a sum of an area of the main phase M and the area of the subphase S satisfies the following expression.

0.03≤RS≤0.3

Here, the ratio RS is a value that is measured in one entire sectional surface of the dielectric film 40. In general, the subphase S substantially and homogeneously exists in the sectional surface, and in this case, the ratio RS can be calculated on the basis of a partial region in the sectional surface.

A lower limit of the ratio RS can be 0.05, and an upper limit can be 0.2.

In the sectional surface of the dielectric film 40, an area other than the main phase M and the subphase S may be less than or equal to 10%, may be less than or equal to 5%, may be less than or equal to 1%, or may be 0%.

The thickness of the dielectric film 40 is not limited, but for example, can be 10 nm to 2000 nm, and is preferably 50 nm to 1000 nm.

In addition, the thickness of the dielectric film can be measured by obtaining a sliced sample of a laminated body including the dielectric film with a focused ion beam (FIB), and by observing the sliced sample with transmission electron microscopy (TEM).

Such a dielectric film is excellent in both of DC bias properties and temperature properties. The reason is not obvious, but the present inventors consider as follows.

The expression of a relative permittivity of an oxide having a perovskite-like crystalline structure is caused by an ion displacement of each element with respect to a voltage, and in a case where the voltage is strong, the ion displacement is saturated, and thus, the relative permittivity is decreased by a DC bias. In the ion displacement of the perovskite-like crystalline structure, a combination of bonding between the ions on the site A and the site B and oxygen ions is important, and it is considered that the degree of freedom of each binding increases when the perovskite-like crystalline structure containing at least one element E1 selected from the group consisting of Bi, Na, and K, and Ti contains at least one element E2 selected from Sr, Ba, and Ca, and thus, the size of the DC bias at which the ion displacement is saturated increases.

In addition, in the embodiment of the first invention, the dielectric film 40 has a structure having the main phase M and the subphase S. It is considered that the main phase M and the subphase S have different thermal expansion coefficients, and thus, both of the DC bias properties and the temperature properties of the permittivity are improved by suppressing a phase transition of the main phase. In particular, it is considered that the ratio RS of the area of the subphase S to the sum of the area of the main phase M and the area of the subphase S satisfies the above expression, and thus, the phase transition according to a temperature change is effectively suppressed.

In a case where the ratio RS is excessively small, it is difficult to obtain the effects described above. On the other hand, in a case where the ratio RS is excessively large, the permittivity decreases.

The dielectric film according to the embodiment of the first invention may contain a trace amount of impurities, accessory components, and the like, within a range in which the effects of the first invention are obtained. Examples of such components include Cr, Mo, and the like.

For example, the dielectric film may further contain at least one type of rear earth element selected from the group consisting of scandium (Sc), yttrium (Y), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu). The dielectric film further contains the rear earth element, and thus, there is a case where the DC bias properties of the dielectric film are improved.

(Manufacturing Method of Dielectric Film)

The dielectric film described above, for example, can be manufactured by the following method.

First, an oxide film that has all of the compositions described above and does not have the subphase S is formed by a known method. Examples of a film formation method include a vacuum deposition method, a sputtering method, a pulsed laser deposition (PLD) method, a metal-organic chemical vapor deposition (MOCVD) method, a metal organic decomposition (MOD) method, a sol-gel method, a chemical solution deposition (CSD) method, and the like.

Specifically, a ratio of a metal element in a raw material composition that is used in each of the film formation methods may be in the range of all of the compositions of the dielectric film described above. Furthermore, there is a case where a raw material (a deposition material, various target materials, an organic metal material, and the like) that is used in the film formation includes a trace amount of impurities, accessory components, and the like, but there is no particular problem insofar as desired dielectric properties can be obtained.

For example, in the case of using the sputtering method, first, an oxide target having the metal composition described above is prepared. Specifically, a powder of a compound containing each metal, for example, a carbonate, an oxide, a hydroxide, and the like are prepared, are mixed such that the ratio of the metal element is within the range described above, and thus, a mixed powder is obtained. It is preferable that the mixing, for example, is performed in water by using a ball mill or the like. Next, the mixed powder is molded, and thus, a molded body is obtained. A molding pressure, for example, can be 10 Pa to 200 Pa.

After that, the obtained molded body is burned, and thus, a burned body is obtained. As a burning condition, a retention temperature can be 900° C. to 1300° C., a temperature retention time can be 1 hour to 10 hours, and an atmosphere can be an oxidation atmosphere such as the air. Finally, the obtained burned body is processed into the shape of a disk, and thus, a sputtering target can be obtained.

Next, the obtained target is sputtered, and thus, the dielectric film described above is formed on a base material, as a deposited film. A sputtering condition is not particularly limited, but radio-frequency (RF) sputtering is preferable, a voltage can be 100 W to 300 W, and as an atmosphere, an oxygen-containing atmosphere is preferable, and in particular, an oxygen-containing argon gas atmosphere is preferable, a ratio of argon (Ar)/oxygen (O₂) is preferably 1/1 to 5/1, and a substrate temperature can be preferably a room temperature to 200° C.

The oxide film is formed by sputtering, and then, a rapid thermal annealing (RTA) treatment is performed in a reduction atmosphere, and thus, the subphase S is formed. Examples of the reduction atmosphere include a hydrogen-containing inert gas atmosphere. Examples of the inert gas include argon gas and nitrogen. A temperature increase rate is preferably greater than or equal to 100° C./minute, an annealing time is preferably 0.5 minutes to 120 minutes, and an annealing temperature is preferably higher than or equal to 700° C. and lower than or equal to 1000° C.

In metals configuring a dielectric substance, Bi is relatively most easily reduced, and thus, the subphase S can be formed by such a treatment. For example, it is possible to adjust the area of the subphase S by adjusting a hydrogen concentration, the annealing time, and the annealing temperature.

(Thin Film Capacitor According to First Embodiment)

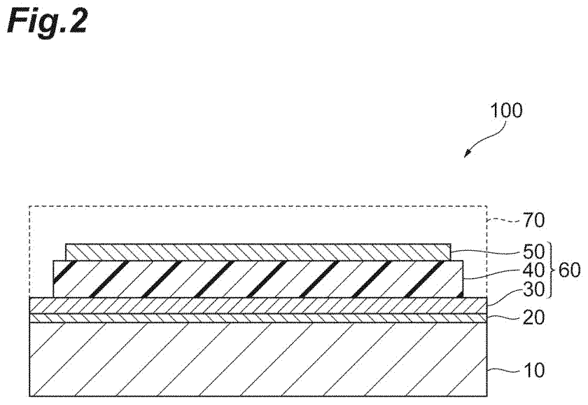

Subsequently, a thin film capacitor will be described as an example of an electronic component including a dielectric film according to a first embodiment of the first invention, with reference to FIG. 2.

A thin film capacitor 100 according to the first embodiment includes a substrate 10, a cohesive film 20, a lower electrode 30, a dielectric film 40, and an upper electrode 50, in this order.

(Substrate)

The substrate 10 supports the cohesive film 20, the lower electrode 30, the dielectric film 40, and the upper electrode 50 that are formed thereon. The material of the substrate 10 is not particularly limited insofar as the material has a mechanical strength at which each of the layers described above can be supported. Examples of the substrate 10 include a metal substrate selected from a single crystal substrate such as an Si single crystal, an SiGe single crystal, a GaAs single crystal, an InP single crystal, an SrTiO₃ single crystal, an MgO single crystal, an LaAlO₃ single crystal, a ZrO₂ single crystal, an MgAl₂O₄ single crystal, and an NdGaO₃ single crystal; a ceramic polycrystal substrate such as an Al₂O₃ polycrystal, a ZnO polycrystal, and an SiO₂ polycrystal; and Ni, Cu, Ti, W, Mo, Al, Pt, and an alloy thereof. An Si single crystal substrate is preferable from the viewpoint of a low cost, processability, and the like.

The thickness of the substrate 10, for example, can be 10 μm to 5000 μm. In a case where the thickness is excessively small, the mechanical strength may not be ensured, and in a case where the thickness is excessively large, the electronic component may not be downsized.

An electrical resistivity of the substrate 10 described above is different in accordance with the material of the substrate. In a case where the substrate is configured of a material having a low electrical resistivity, a current is leaked to the substrate 10 side when the thin film capacitor is operated, and thus, electric properties of the thin film capacitor may be affected. For this reason, in a case where the electrical resistivity of the substrate 10 is low, it is preferable that the surface is subjected to an electric insulating treatment such that the current when the capacitor is operated does not flow to the substrate 10.

For example, in a case where the substrate 10 is the Si single crystal substrate, it is preferable that an insulating film is formed on the surface of the substrate 10. A material configuring the insulating film and the thickness of the insulating film are not particularly limited insofar as the insulating between the substrate 10 and the lower electrode 30 is sufficiently ensured. Examples of the material configuring the insulating film include SiO₂, Al₂O₃, and Si₃Nₓ. In addition, it is preferable that the thickness of the insulating film is greater than or equal to 0.01 μm. It is preferable that the insulating film is provided in the substrate 10 on the cohesive film 20 side (the lower electrode 30 side). The insulating film can be formed by a known film formation method such as a thermal oxidation method and a chemical vapor deposition (CVD) method.

(Cohesive Film)

The cohesive film 20 is disposed between the substrate 10 and the lower electrode 30, and thus, cohesiveness between the substrate 10 and the lower electrode 30 is improved. The material of the cohesive film 20 is not particularly limited insofar as the cohesiveness between the substrate 10 and the lower electrode 30 can be sufficiently ensured. For example, in a case where the lower electrode 30 is a Cu film, the cohesive film 20 can be a Cr film, and in a case where the lower electrode 30 is a Pt film, the cohesive film 20 can be a Ti film. The thickness of the cohesive film 20, for example, can be 5 nm to 50 nm.

(Lower Electrode)

The lower electrode 30 is formed into the shape of a thin film on the substrate 10 via the cohesive film 20. The lower electrode 30 is an electrode that interposes the dielectric film 40 together with the upper electrode 50 to function as a capacitor. A material configuring the lower electrode 30 is not particularly limited insofar as the material has conductivity. For example, a metal such as Pt, Ru, Rh, Pd, Ir, Au, Ag, Cu, and Ni, and an alloy thereof, a conductive oxide, or the like is exemplified.

The thickness of the lower electrode 30 not particularly limited insofar as the lower electrode functions as an electrode. It is preferable that the thickness of the lower electrode 30 is greater than or equal to 10 nm, and it is preferable that the thickness is less than or equal to 300 nm, from the viewpoint of film-thinning.

(Dielectric Film)

The dielectric film 40 is the dielectric film described above. A lower end surface of the dielectric film is in contact with the cohesive film 20, and an upper end surface is in contact with the upper electrode 50. The thickness of the dielectric film 40 can be 10 nm to 2000 nm, and is preferably 50 nm to 1000 nm. The thickness of the dielectric film 40 can be measured by drilling the thin film capacitor 100 including the dielectric film 40 with a focused ion beam (FIB) processing device, and by observing a sectional surface that is obtained with a scanning electron microscope (SEM).

(Upper Electrode)

The upper electrode 50 is formed into the shape of a thin film on an upper surface of the dielectric film 40. The upper electrode 50 is an electrode that interposes the dielectric film 40 together with the lower electrode 30 described above to function as a capacitor.

As with the lower electrode 30, the material of the upper electrode 50 is not particularly limited insofar as the material have conductivity. Examples of the material include a metal such as Pt, Ru, Rh, Pd, Ir, Au, Ag, Cu, and Ni, and an alloy thereof, or a conductive oxide, and may be the same material as that of the lower electrode 30, or may be a material different from that of the lower electrode. The thickness of the upper electrode 50 can be set as with the lower electrode 30.

In addition, the thin film capacitor 100 may include a protective film 70 for covering a lateral surface of the dielectric film 40, or the like and for blocking the dielectric film 40 from the external atmosphere. Examples of the material of the protective layer include a resin such as epoxy.

Furthermore, the shape of the thin film capacitor 100 is not particularly limited, but in general, the thin film capacitor is in the shape of a rectangular parallelepiped when seen from a thickness direction. In addition, the dimension thereof is not also particularly limited, but a thickness or a length may be a suitable dimension in accordance with an application.

The lower electrode 30, the dielectric film 40, and the upper electrode 50 form a capacitor portion 60. In a case where the lower electrode 30 and the upper electrode 50 apply a voltage between the electrodes by being connected to the external circuit, the dielectric film 40 represents a predetermined electrostatic capacitance and exhibits a function as a capacitor. In particular, in the embodiment of the first invention, the dielectric film 40 described above is used, and thus, it is possible to make high DC bias properties and high temperature properties compatible.

Further, the dielectric film 40 having the subphase S of which the oxygen concentration is relatively low, that is, metallic properties are strong is in contact with the upper electrode 50 and the lower electrode 30, and thus, the cohesiveness between each of the electrodes and the dielectric film 40 is improved, and the occurrence of a crack in the dielectric film can be suppressed.

(Dielectric Film According to Second Embodiment)

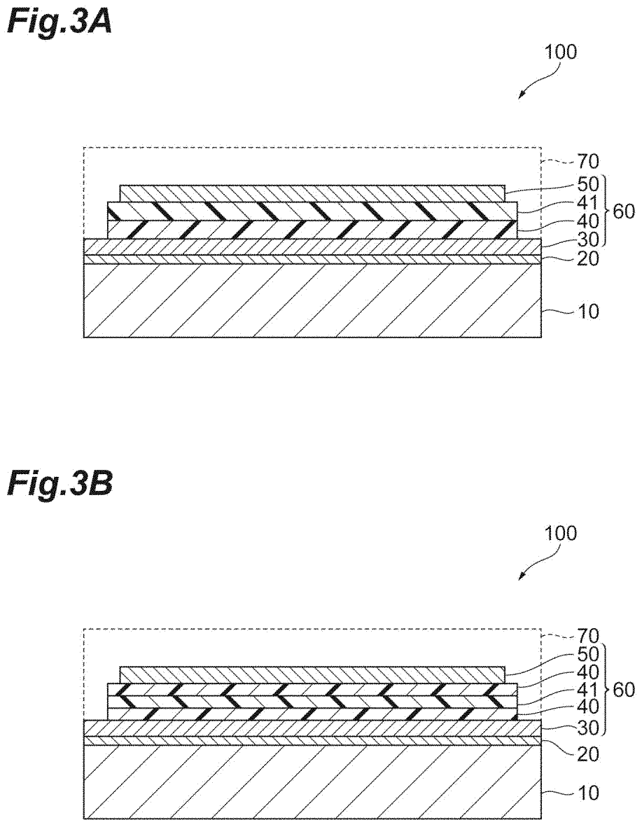

Next, the thin film capacitor 100 according to a second embodiment of the first invention will be described with reference to FIG. 3A and FIG. 3B. The thin film capacitor 100 according to the second embodiment is different from the thin film capacitor 100 according to the first embodiment in that the electrode is not in contact with both surfaces of the dielectric film 40, but the electrode is in contact with only one surface of the dielectric film 40, and another dielectric film 41 is formed on the other surface of the dielectric film 40.

Specifically, in FIG. 3A, another dielectric film 41 is provided between the upper electrode 50 and the dielectric film 40. Another dielectric film 41 may be provided between the dielectric film 40 and the lower electrode 30. In addition, in FIG. 3B, there are two dielectric films 40, and one dielectric film 40 is in contact with the upper electrode 50, the other dielectric film 40 is in contact with the lower electrode 30, and another dielectric film 41 is provided between the dielectric films 40.

Another dielectric film 41 is a film that has the same compositions as those of the dielectric film 40 but does not have the subphase S. In a case where a laminated dielectric substance including the dielectric film 41 and the dielectric film 40 is provided between the electrodes, the ratio RS described above is defined with respect to the entire laminated dielectric substance including all of the dielectric film 41 and the dielectric film 40. A ratio between the thickness of the dielectric film 40 and the thickness of another dielectric film 41 is arbitrary.

In addition, at least one electrode is in contact with the dielectric film 40, and thus, adhesiveness with respect to one electrode increases, the cohesiveness between the electrode and the dielectric film 40 is improved, and the occurrence of a crack in the dielectric film can be suppressed.

(Manufacturing Method of Thin Film Capacitor)

Next, an example of a manufacturing method of the thin film capacitor 100 illustrated in FIG. 2 will be described below.

First, the substrate 10 is prepared, and the cohesive film 20 and the lower electrode 30 are formed on the substrate 10 by a known film formation method such as a sputtering method.

The lower electrode 30 is formed, and then, a thermal treatment may be performed in order to improve cohesiveness between the cohesive film 20 and the lower electrode 30 and to improve the stability of the lower electrode 30. For example, a temperature increase rate is preferably 10° C./minute to 2000° C./minute, and is more preferably 100° C./minute to 1000° C./minute, as a thermal treatment condition. A retention temperature in the thermal treatment is preferably 400° C. to 800° C., and a retention time is preferably 0.1 hours to 4.0 hours. In a case where the thermal treatment condition is out of the range described above, a cohesion failure between the cohesive film 20 and the lower electrode 30, and irregularities easily occur on the surface of the lower electrode 30. As a result thereof, a decrease in the dielectric properties of the dielectric film 40 easily occurs.

Subsequently, the dielectric film 40 is formed on the lower electrode 30 by the method described above. Furthermore, as with the second embodiment (FIG. 3A and FIG. 3B), in order to form a laminated body of a plurality of dielectric films including the dielectric film 40, each of the dielectric films may be sequentially laminated.

Next, the upper electrode 50 is formed on the formed dielectric film 40 by using a known film formation method such as a sputtering method.

According to such a step, as illustrated in FIG. 2, the thin film capacitor 100 is obtained in which the capacitor portion (the lower electrode 30, the dielectric film 40, and the upper electrode 50) 60 is formed on the substrate 10 via the cohesive film 20. Furthermore, the protective film 70 protecting the dielectric film 40 may be formed by a known film formation method in order to cover a portion in which at least the dielectric film 40 is exposed to the outside.

### Modification Example

As described above, the embodiments of the first invention have been described, but the first invention is not limited to the embodiments described above, and may be modified in various aspects, within the scope of the first invention.

In addition, in the embodiments of the first invention described above, the cohesive film 20 is formed in order to improve the cohesiveness between the substrate 10 and the lower electrode 30, but in a case where the cohesiveness between the substrate 10 and the lower electrode 30 can be sufficiently ensured, the cohesive film 20 can be omitted. In addition, in a case where a metal that can be used as an electrode, such as Cu and Pt, and an alloy thereof, an oxide conductive material, or the like is used as the material configuring the substrate 10, the cohesive film 20 and the lower electrode 30 can be omitted.

In addition, an amorphous film or a crystalline film such as Si₃Nₓ, SiOₓ, Al₂Oₓ, ZrOₓ, and Ta₂Oₓ may be provided between the dielectric film 40 or the dielectric film 41 and the electrode, as a buffer layer. In this case, it is possible to adjust a temperature change of the impedance or the relative permittivity in the entire laminated body of the dielectric film including the plurality of dielectric films while using the properties of the dielectric film 40.

### Examples of First Invention

Hereinafter, the first invention will be described in more detail by using examples and comparative examples. However, the first invention is not limited to the following examples.

### Examples 1 to 17 and Comparative Examples 1 to 3

First, a sputtering target that was necessary in the formation of the dielectric film 40 was prepared by a solid-phase method as follows.

Powders of barium carbonate, strontium carbonate, calcium carbonate, titanium oxide, bismuth oxide, potassium carbonate, and sodium carbonate were prepared as a raw material powder for preparing a target. The powders were respectively weighed such that the number of atoms of each of the metals became compositions shown in Table 1.

The weighed raw material powder preparing a target was subjected to wet mixing for 20 hours in a ball mill by using water as a solvent. A mixed powder slurry that was obtained was dried at 100° C., and thus, a mixed powder was obtained. The obtained mixed powder was subjected to press molding by a press, and thus, a molded body was obtained. As a molding condition, a pressure was 100 Pa, a temperature was 25° C., and a press time was 3 minutes.

After that, the obtained molded body was burned, and thus, a burned body was obtained. As a burning condition, a retention temperature was 1100° C., a temperature retention time was 5 hours, and an atmosphere was in the air.

The obtained burned body was processed to have a diameter of 80 mm and a thickness of 5 mm by a surface grinder and a cylindrical polishing machine, and thus, the sputtering target for forming the dielectric film 40 was obtained.

Subsequently, an Si wafer having a thickness of 500 μm was subjected to a thermal treatment in a dry atmosphere of oxidized gas, and thus, an SiO₂ film having a thickness of 500 nm was formed on a wafer surface, and was set to a substrate. First, a Cr thin film as a base electrode was formed to have a thickness of 20 nm on the surface of the substrate by a sputtering method. Further, a Pt thin film was formed to have a thickness of 100 nm on the Cr thin film that was formed as described above by a sputtering method, and was set to a lower electrode.

Next, a dielectric film was formed to have a thickness of 500 nm on the lower electrode, with the sputtering target that was prepared as described above, by a sputtering method. As a sputtering condition, an atmosphere was Ar/O₂=3/1, a pressure was 1.0 Pa, a radio-frequency voltage was 200 W, and a substrate temperature was 100° C.

The dielectric film was formed, and then, the dielectric film was subjected to a rapid thermal annealing (RTA) treatment at 900° C. for 1 minute in a hydrogen-containing nitrogen atmosphere and in an annealing condition where a temperature increase rate was 900° C./min, and thus, the dielectric film 40 having the subphase S was obtained.

Furthermore, in Examples 1 to 3 and Comparative Examples 1 to 3, hydrogen concentrations were changed to each other, and thus, the ratios RS of the dielectric films 40 were changed to each other. In Comparative Example 1, the hydrogen concentration was zero, and thus, a dielectric film other than the dielectric film 40 was obtained.

Next, a Pt thin film was formed to have a diameter of 200 μm and a thickness of 100 nm on the obtained dielectric film with a mask by a sputtering method, and was set to an upper electrode. According to such steps described above, a thin film capacitor having the configuration illustrated in FIG. 2 was obtained.

A sectional surface of the dielectric film was analyzed by STEM-EDS, and the dielectric film of the examples had a structure having the main phase M of a continuous phase of which the oxygen concentration was relatively high and the subphase S of a disperse phase of which the oxygen concentration is relatively low. Furthermore, a region of which an oxygen concentration is lower than the oxygen concentration of the main phase M by greater than or equal to 20 at % was determined as the subphase S. The oxygen concentration of the main phase was approximately 50 at %, and an average oxygen concentration of the subphases was approximately 10 at % to 20 at %.

In addition, the main phase contained Bi, Ti, the element E1, the element E2, and oxygen, and the subphase mainly contained Bi and oxygen.

A crystalline structure of the dielectric film was measured and analyzed with an XRD measurement device (Smartlab, manufactured by Rigaku Corporation) by an X-ray diffraction method. As a result thereof, it was checked that the main phase had a perovskite-like crystalline structure.

In addition, all metal compositions of the dielectric film were analyzed by using X-ray fluorescence (XRF) analysis, and it was checked that the metal compositions of the dielectric film were identical to the compositions shown in Table 1.

In all of the obtained thin film capacitor, a relative permittivity at the time of applying a DC bias was measured by the following method.

(DC Bias Properties: Relative Permittivity when Direct Voltage is Applied)

The relative permittivity at the time of applying the DC bias was calculated (no unit of quantity required) from an electrostatic capacitance, an effective electrode area, a distance between the electrodes, and a vacuum permittivity that were measured in a condition of a room temperature of 25° C., a frequency of 1 kHz, and an input signal level (a measurement voltage) of 1.0 Vrms by using a digital LCR meter (4284A, manufactured by Hewlett-Packard Company), while applying a DC bias of 10 V/μm to the thin film capacitor in a thickness direction. It is preferable that the relative permittivity at the time of applying the DC bias is high, as the dielectric film, and it is preferable that the relative permittivity at the time of applying the DC bias is greater than or equal to 600. Results are shown in Table 1.

Furthermore, for reference, the relative permittivity was also measured without applying the DC bias. A measurement condition was the same except that the DC bias was not applied. Results are shown in Table 1.

(Temperature Properties of Relative Permittivity)

The relative permittivity was measured while changing the temperature of the thin film capacitor to 85° C. from −55° C., and a change rate of the relative permittivity (a maximum change rate with respect to the relative permittivity at 25° C.) was calculated, as temperature properties of the relative permittivity. Furthermore, the relative permittivity at each temperature was calculated (no unit of quantity required) from the electrostatic capacitance, the effective electrode area, the distance between the electrodes, and the vacuum permittivity that were measured in a condition of a frequency of 1 kHz and an input signal level (a measurement voltage) of 1.0 Vrms. In this example, a case where the change rate is ±15% is determined as excellent.

As obvious from Table 1, in a dielectric substance satisfying the ratio RS described above, the improvement of the DC bias properties and the improvement of the change rate of the relative permittivity were checked.

### Example 24

A capacitor of Example 24 was obtained as with Example 1, except that an atom composition of the dielectric film was changed as shown in Table 2, and a rapid thermal annealing treatment was performed in a hydrogen-containing nitrogen atmosphere, a dielectric film having the subphase S of which the thickness was 200 nm was formed, and then, a rapid thermal annealing treatment was performed thereon in an air atmosphere, and a dielectric film not having the subphase S of which the thickness was 300 nm was formed, instead of forming the dielectric film having the subphase S of which the thickness was 500 nm by performing a rapid thermal annealing treatment in a hydrogen-containing nitrogen atmosphere. The ratio RS in all of the dielectric films was 0.2.

### Example 25

A thin film capacitor of Example 25 was obtained as with Example 24, except that a rapid thermal annealing treatment was performed in a hydrogen-containing nitrogen atmosphere, a dielectric film having the subphase S of which the thickness was 100 nm was formed, and then, a rapid thermal annealing treatment was performed in an air atmosphere, a dielectric film not having the subphase S of which the thickness was 300 nm was formed, and then, a rapid thermal annealing treatment was performed in a hydrogen-containing nitrogen atmosphere, and the dielectric film 40 having the subphase S of which the thickness was 100 nm was formed. The ratio RS in all of the dielectric films was 0.2.

### Comparative Example 4

A capacitor of Comparative Example 4 was obtained as with Example 24, except that a rapid thermal annealing treatment was performed in an air atmosphere, and a dielectric film not having the subphase S of which the thickness was 500 nm was formed.

[Effect of Occurrence of Crack According to Indentation Test]

In Examples 24 and 25 and Comparative Example 4, the presence or absence of the occurrence of a crack in the dielectric film according to an indentation test was evaluated.

Test Method: Load Indentation Test of Nanoindentation Device

Load: 2 mN and 8 mN

Specifically, an indenter was pressed from an upper surface of the capacitor to be the load described above, and the presence or absence of a crack in the dielectric film of the capacitor was checked by an optical microscope.

An indentation depth at the time of being pressed at 8 mN was 10% of the thickness of the dielectric film.

TABLE 1

| | Ratio of number of atoms | | | | | | | | | | | | Relative | Relative | Change rate (%) of |
|---|---|---|---|---|---|---|---|---|---|---|---|---|---|---|---|
| | | E1 | | | | | E2 | | | | | Ratio | permittivity | permittivity | relative permittivity |
| | Bi | Na | K | E1 | Bi + E1 | E1/B1 | Sr | Ba | Ca | E2 | Ti | RS | @0 V | @10 V/μm | at −55° C. to 85° C. |
| Example 1 | 35 | 35 | 0 | 35 | 70 | 1.00 | 30 | 0 | 0 | 30 | 100 | 0.05 | 771 | 671 | −10 |
| Example 2 | 35 | 35 | 0 | 35 | 70 | 1.00 | 30 | 0 | 0 | 30 | 100 | 0.1 | 755 | 680 | −8 |
| Example 3 | 35 | 35 | 0 | 35 | 70 | 1.00 | 30 | 0 | 0 | 30 | 100 | 0.2 | 716 | 687 | −6 |
| Comparative | 35 | 35 | 0 | 35 | 70 | 1.00 | 30 | 0 | 0 | 30 | 100 | 0 | 795 | 610 | −18 |
| Example 1 | | | | | | | | | | | | | | | |
| Comparative | 35 | 35 | 0 | 35 | 70 | 1.00 | 30 | 0 | 0 | 30 | 100 | 0.5 | 600 | 510 | −20 |
| Example 2 | | | | | | | | | | | | | | | |
| Comparative | 35 | 35 | 0 | 35 | 70 | 1.00 | 30 | 0 | 0 | 30 | 100 | 0.8 | 300 | 255 | −30 |
| Example 3 | | | | | | | | | | | | | | | |
| Example 4 | 45 | 45 | 0 | 45 | 90 | 1.00 | 10 | 0 | 0 | 10 | 100 | 0.2 | 720 | 684 | −7 |
| Example 5 | 25 | 25 | 0 | 25 | 50 | 1.00 | 50 | 0 | 0 | 50 | 100 | 0.2 | 702 | 667 | −6 |
| Example 6 | 15 | 15 | 0 | 15 | 30 | 1.00 | 70 | 0 | 0 | 70 | 100 | 0.2 | 680 | 646 | −7 |
| Example 7 | 45 | 45 | 0 | 45 | 90 | 1.00 | 0 | 10 | 0 | 10 | 100 | 0.2 | 734 | 697 | −6 |
| Example 8 | 35 | 35 | 0 | 35 | 70 | 1.00 | 0 | 30 | 0 | 30 | 100 | 0.2 | 729 | 693 | −5 |
| Example 9 | 25 | 25 | 0 | 25 | 50 | 1.00 | 0 | 50 | 0 | 50 | 100 | 0.2 | 715 | 679 | −6 |
| Example 10 | 15 | 15 | 0 | 15 | 30 | 1.00 | 0 | 70 | 0 | 70 | 100 | 0.2 | 692 | 658 | −6 |
| Example 11 | 45 | 45 | 0 | 45 | 90 | 1.00 | 0 | 0 | 10 | 10 | 100 | 0.2 | 706 | 671 | −7 |
| Example 12 | 35 | 35 | 0 | 35 | 70 | 1.00 | 0 | 0 | 30 | 30 | 100 | 0.2 | 702 | 667 | −6 |
| Example 13 | 25 | 25 | 0 | 25 | 50 | 1.00 | 0 | 0 | 50 | 50 | 100 | 0.2 | 689 | 654 | −5 |
| Example 14 | 15 | 15 | 0 | 15 | 30 | 1.00 | 0 | 0 | 70 | 70 | 100 | 0.2 | 674 | 640 | −6 |
| Example 15 | 35 | 0 | 35 | 35 | 70 | 1.00 | 30 | 0 | 0 | 30 | 100 | 0.2 | 711 | 675 | −6 |
| Example 16 | 35 | 0 | 35 | 35 | 70 | 1.00 | 0 | 30 | 0 | 30 | 100 | 0.2 | 720 | 684 | −7 |
| Example 17 | 35 | 0 | 35 | 35 | 70 | 1.00 | 0 | 0 | 30 | 30 | 100 | 0.2 | 693 | 658 | −5 |

TABLE 2

| | | | | | | | | Indentation test | | | | |
|---|---|---|---|---|---|---|---|---|---|---|---|---|
| | | | | | | | Ratio RS in all | (presence or absence | | Relative | Relative | Change rate (%) of |
| | | E1 | E2 | | | | two dielectric | of crack) | | permittivity | permittivity | relative permittivity |
| | Bi | Na | Sr | Bi + E1 | E1/B1 | Ti | films | 2 mN | 10 mN | @0 V | @10 V/μm | at −55° C. to 85° C. |
| Example 24 | 45 | 45 | 10 | 90 | 1.00 | 100 | 0.2 | Absent | Absent | 720 | 684 | −7 |
| Example 25 | 45 | 45 | 10 | 90 | 1.00 | 100 | 0.2 | Absent | Absent | 721 | 685 | −6 |
| Comparative | 45 | 45 | 10 | 90 | 1.00 | 100 | 0 | Absent | Present | 800 | 605 | −20 |
| Example 4 | | | | | | | | | | | | |

In addition, from the comparison of Examples 24 and 25 with Comparative Example 4, it was checked that in a case where the dielectric film 40 was in contact with the electrode, the occurrence of a crack was suppressed.

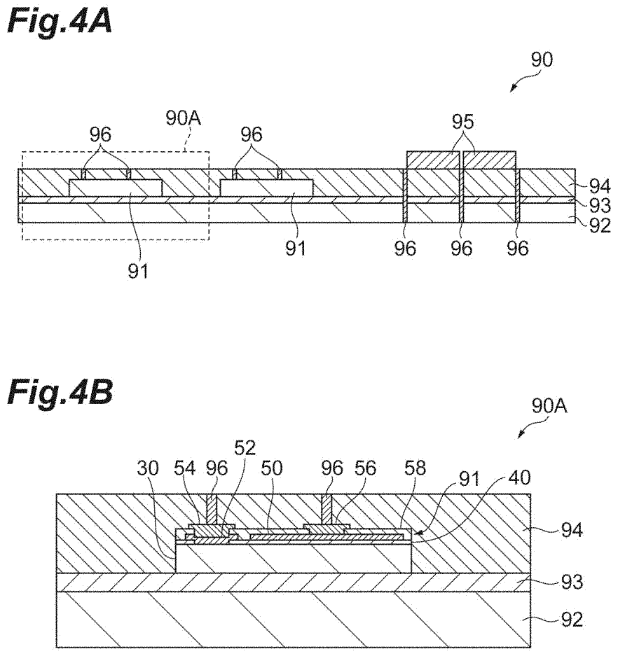

### REFERENCE SIGNS LIST OF FIG. 1, FIG. 2, FIG. 3A, FIG. 3B, FIG. 4A, AND FIG. 4B

10: substrate, 20: cohesive film, 30: lower electrode, 40: dielectric film (dielectric thin film), 50: upper electrode, 90: electronic circuit board, 91, 100: thin film capacitor.

### Embodiment of Second Invention

Hereinafter, a preferred embodiment of the second invention will be described with reference to the drawings. In the drawings, the same reference numerals are applied to the same constituents. The second invention is not limited to the following embodiment.

A thin film capacitor will be described as an example of an electronic component according to the embodiment of the second invention. However, the electronic component is not limited to the thin film capacitor.

(Structure of Thin Film Capacitor)

FIG. 2 is a sectional surface of the thin film capacitor 100 that is perpendicular to the surface of the dielectric thin film 40. In other words, FIG. 2 is the sectional surface of the thin film capacitor 100 that is parallel to a thickness direction of the dielectric thin film 40. As illustrated in FIG. 2, the thin film capacitor 100 according to the embodiment of the second invention includes the substrate 10, the cohesive film 20 overlaid on the substrate 10, the lower electrode 30 overlaid on the cohesive film 20, the dielectric thin film 40 overlaid on the lower electrode 30, the upper electrode 50 overlaid on the dielectric thin film 40, and the protective film 70 covering the lower electrode 30, the dielectric thin film 40, and the upper electrode 50.

The capacitor portion 60 includes the lower electrode 30, the dielectric thin film 40, and the upper electrode 50. The lower electrode 30 and the upper electrode 50 are connected to an external circuit. A voltage is applied to the dielectric thin film 40 that is positioned between the lower electrode 30 and the upper electrode 50, and thus, dielectric polarization of the dielectric thin film 40 occurs, and a charge is accumulated in the capacitor portion 60.

The thin film capacitor 100, for example, may be in the shape of a rectangular parallelepiped. However, the shape and the dimension of the entire thin film capacitor are not limited.

(Dielectric Thin Film)

The dielectric thin film 40 according to the embodiment of the second invention contains an oxide having a perovskite structure. The oxide contains bismuth (Bi), the element E1, the element E2, and titanium (Ti). The element E1 is at least one alkali metal element selected from the group consisting of sodium (Na) and potassium (K). The element E2 is at least one alkali earth metal element selected from the group consisting of calcium (Ca), strontium (Sr), and barium (Ba).

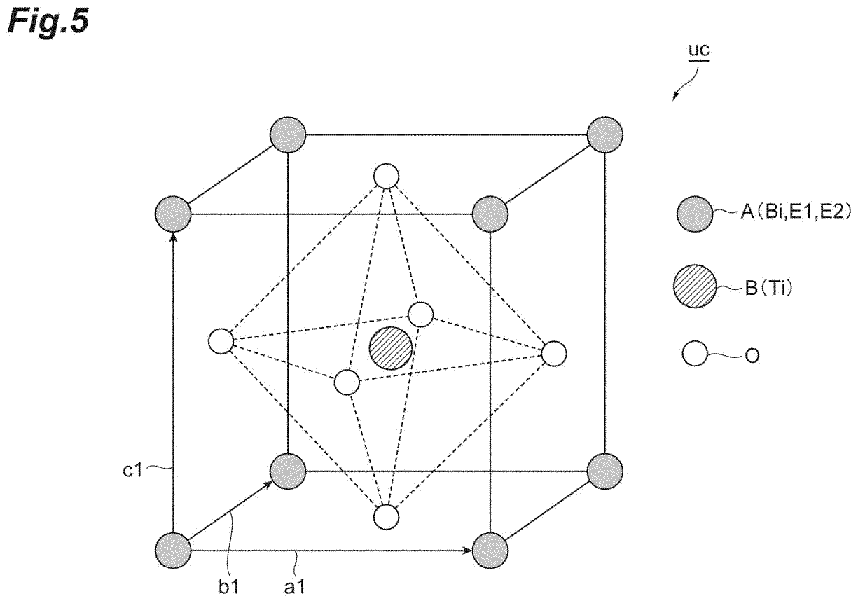

A unit cell of the perovskite structure is illustrated in FIG. 5. A unit cell uc of the perovskite structure may consist of an element that is positioned on the site A, an element that is positioned on the site B, and oxygen (O). The element that is positioned on the site A may be at least one type selected from the group consisting of Bi, the element E1, and the element E2. The element that is positioned on the site B may be Ti. In FIG. 5, a1, b1, and c1 are basic vectors configuring cubic crystals or tetragonal crystals of the perovskite structure.

The dielectric thin film 40 according to the embodiment of the second invention is more excellent in DC bias properties than the dielectric thin film of the related art. The DC bias properties are properties in which it is difficult for the relative permittivity to decrease in accordance with an increase in the intensity of a direct-current electric field to be applied to the dielectric thin film 40. The following description relevant to the DC bias properties of the dielectric thin film 40 includes a hypothesis or a theoretic speculation. The reason that the DC bias properties of the dielectric thin film 40 are improved is not necessarily limited to the following mechanism.

Dielectric properties of the oxide having a perovskite structure are caused by the displacement of ions of each element configuring the oxide at a voltage. A displacement amount of each of the ions is saturated in accordance with an increase in a voltage, and thus, a relative permittivity of the oxide easily decreases. Even in a case where the intensity of the voltage is the same, the vibration of each of the ions configuring the oxide decreases due to the application of a direct voltage. However, in the case of the embodiment of the second invention, Bi, the element E1, and the element E2, configuring the oxide, are different from each other in an atom radius or an ion radius. Therefore, Bi, the element E1, and the element E2 are disposed on the site A, and thus, there is a spatial room in the perovskite structure. As a result thereof, Ti is easily moved in the perovskite structure, and the dielectric thin film 40 is easily polarized, and thus, the DC bias properties of the dielectric thin film 40 are improved. In other words, the intensity of the direct-current electric field at which the ion displacement amount of Ti or the like is saturated is increased by a combination of Bi, the element E1, and the element E2. As described below, in a case where [Bi]/[E2] is greater than or equal to 0.214 and less than or equal to 4.500, the DC bias properties are easily improved by the mechanism described above.

In a case where the oxide having a perovskite structure contains Bi, the element E1, and Ti, but does not contain the element E2, a Curie point of the oxide is approximately 300° C. However, the oxide further contains the element E2, in addition to Bi, the element E1, and Ti, and thus, the Curie point of the oxide is close to a room temperature. As a result thereof, an absolute value of the relative permittivity of the oxide increases and the relative permittivity of the oxide also increases in the direct-current electric field.

In order to downsize an electronic device on which the thin film capacitor 100 is mounted, it is desirable to make the dielectric thin film 40 thinner. In addition, in order to increase an electrostatic capacitance of the thin film capacitor 100, it is also desirable to make the dielectric thin film 40 thinner. However, even in a case where a direct voltage to be applied to the dielectric thin film 40 is constant, the intensity of the direct-current electric field on the dielectric thin film 40 increases in accordance with a decrease in the thickness of the dielectric thin film 40. A relative permittivity of the dielectric thin film 40 easily decreases in accordance with an increase in the intensity of the direct-current electric field. However, the dielectric thin film 40 according to the embodiment of the second invention is more excellent in the DC bias properties than the dielectric thin film of the related art. As a result thereof, even in a case where the thickness of the dielectric thin film 40 is less than that of the dielectric thin film of the related art, a decrease in the relative permittivity of the dielectric thin film 40 is suppressed.

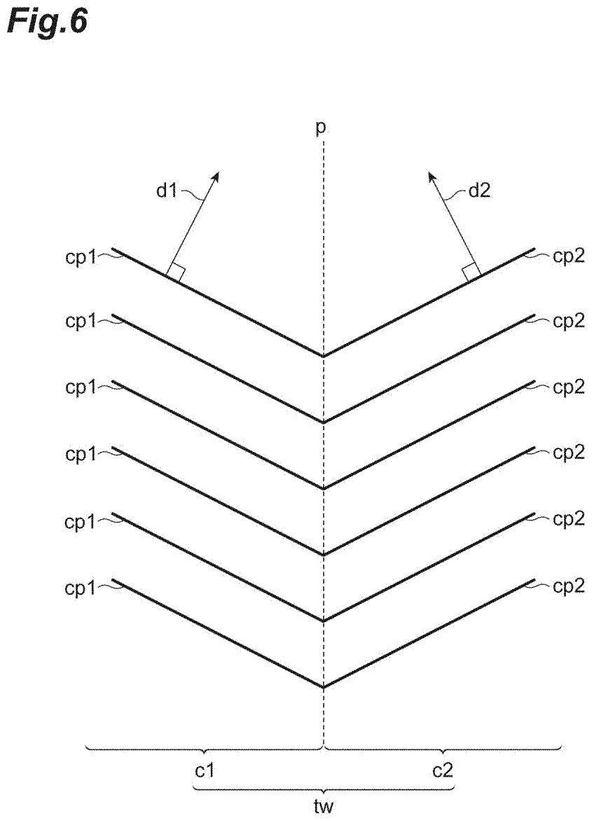

The oxide described above contains twin crystals (crystal twinning). The crystal twinning is a crystal state consisting of two or more homogeneous single crystals that are joined to each other at a constant angle. Each of the single crystals configuring the twin crystals of the oxide has the perovskite structure described above, and each of the single crystals configuring the twin crystals of the oxide contains Bi, the element E1, the element E2, Ti, and O. An example of the twin crystals of the oxide is illustrated in FIG. 6. For example, twin crystals tw of the oxide may consist of first crystals c1 and second crystals c2. The first crystals c1 and the second crystals c2 have plane symmetry with respect to a plane p. FIG. 6 is a sectional surface of the twin crystal tw in a direction perpendicular to a first crystal surface cp1 and a second crystal surface cp2. Therefore, in FIG. 6, the first crystal surface cp1 and the second crystal surface cp2 are represented by a line segment. The first crystal surface cp1 belonging to the first crystals c1 is orientated in a first orientation dl. That is, the first orientation d1 is a normal direction of the first crystal surface cp1. The second crystal surface cp2 belonging to the second crystals c2 is orientated in a second orientation d2. That is, the second orientation d2 is a normal direction of the second crystal surface cp2. The first crystal surface cp1 and the second crystal surface cp2 are an equivalent crystal surface in the perovskite structure, but the first orientation d1 and the second orientation d2 are not parallel to each other. The structure of the twin crystals is not limited to a structure illustrated in FIG. 6.

In a case where the dielectric thin film 40 does not contain the twin crystals of the oxide, a phase transition of the oxide is easily caused in accordance with a temperature change. The relative permittivity of the dielectric thin film 40 is easily changed due to the phase transition. On the other hand, the twin crystals tw of the oxide consist of two or more homogeneous single crystals that are joined to each other at a constant angle, and thus, distortion in the crystalline structure is formed in the oxide. The distortion in the crystalline structure suppresses the progress of the phase transition of the oxide, and thus, a change in the relative permittivity of the dielectric thin film 40 is suppressed. That is, the dielectric thin film 40 contains the twin crystals of the oxide, and thus, it is possible for the dielectric thin film 40 to have excellent temperature properties. Here, the reason that the temperature properties are improved is not necessarily limited to the mechanism described above.

It is possible to check whether or not the dielectric thin film 40 contains the twin crystals of the oxide by the following method.

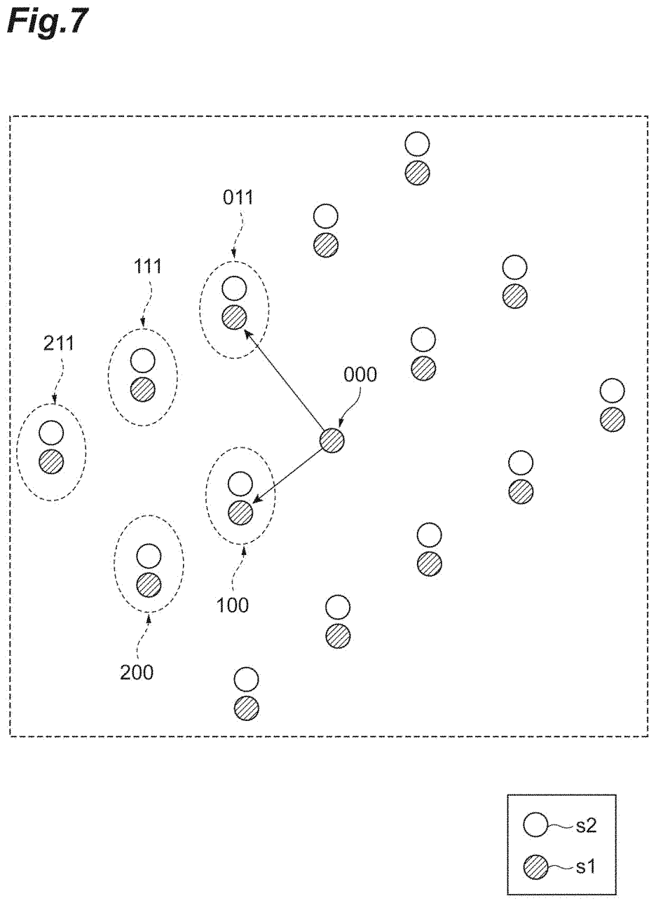

The dielectric thin film 40 is processed with a focused ion beam (FIB), and thus, a slice (a sample) is formed. A crystal lattice image of crystal grains in the slice is captured by a transmission electron microscope (TEM). The dimension of a visual field of the TEM, for example, may be a length of 35 nm×a width of 35 nm. The crystal lattice image of the crystal grains that is captured by the TEM is subjected to fast Fourier transform (FFT), and thus, an FFT pattern is obtained. An example of the FFT pattern is illustrated in FIG. 7. In FIG. 7, 100, 200, 011, 111, and 211 are respectively indices associated with the crystallite orientation in the perovskite structure described above. 000 corresponds to an original point for defining the position of each spot of the FFT pattern. In a case where the crystal grains do not include the twin crystals of the oxide, the FFT pattern includes a plurality of spots, and one spot corresponds to one crystallite orientation. On the other hand, in a case where the crystal grains include the twin crystals of the oxide, two or more spots corresponding to one crystallite orientation appear. That is, in a case where the crystal grains include the twin crystals of the oxide, the spot corresponding to one crystallite orientation is separated into at least two spots. Furthermore, the FFT pattern is different in accordance with a visual field to be observed by the TEM, but the FFT pattern may be a pattern other than that of FIG. 7 insofar as the spot in the FFT pattern can be checked.

In a case where visual fields of 20 sites in the slice (the sample) are observed on the basis of the FFT pattern, it is preferable that the twin crystals are included in at least two sites of 20 sites. The dimension of each of the visual fields is as described above. The dielectric thin film 40 may contain a plurality of crystal grains of the oxide. At least a part of the crystal grains of the plurality of crystal grains may include the twin crystals of the oxide. All of the plurality of crystal grains may include the twin crystals of the oxide. In a case where a grain diameter of the crystal grain is greater than or equal to 150 nm, it is preferable that at least two visual fields in an identical crystal grain are observed.

The content of Bi in the dielectric thin film 40 may be represented by [Bi] mol %. The unit of [Bi] may be atom %. The sum of the contents of the elements E2 in the dielectric thin film 40 may be represented by [E2] mol %. The unit of [E2] may be atom %. [Bi]/[E2] may be greater than or equal to 0.214 and less than or equal to 4.500. [Bi]/[E2] is in the range described above, and thus, the temperature properties and the DC bias properties of the dielectric thin film 40 are easily improved.

The composition of the oxide contained in the dielectric thin film 40 may be represented by Chemical Formula 1a or Chemical Formula 1b described below. x, α, β, s, t, and u described in Chemical Formula 1a and Chemical Formula 1b are real numbers. The unit of each of x, a, P, s, t, and u is mol. Both of Chemical Formula 1a and Chemical Formula 1b satisfy all inequalities 2 to 9 described below.

(1−x)Bi_{1-α-β}Na_{α}K_{β}TiO₃-xCaₛSrₜBaᵤTiO₃ <Chemical Formula 1a>

(Bi_{1-α-β}Na_{α}K_{β})₁₋ₓ(CaₛSrₜBaᵤ)ₓTiO₃ <Chemical Formula 1b>

0<x<1 (2)

0.4<α+β<0.6 (3)

0≤α<0.6 (4)

0≤β<0.6 (5)

0.9<s+t+u≤1.1 (6)

0≤s≤1.1 (7)

0≤t≤1.1 (8)

0≤u≤1.1 (9)

The oxide described above may be a main component of the dielectric thin film 40. In a case where the composition of the oxide contained in the dielectric thin film 40 is represented by Chemical Formula 1a or Chemical Formula 1b described above, the content of the oxide in the dielectric thin film 40 may be greater than or equal to 70 mol % and less than or equal to 100 mol %. Unless the perovskite structure of the oxide is impaired, the dielectric thin film 40 may contain other elements, in addition to Bi, the element E1, the element E2, Ti, and O. That is, the dielectric thin film 40 may contain accessory components or a trace amount of impurities, in addition to the oxide described above. For example, the dielectric thin film 40 may further contain at least one type of element of chromium (Cr) and molybdenum (Mo). The dielectric thin film 40 may further contain at least one type of rear earth element selected from the group consisting of scandium (Sc), yttrium (Y), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu). The dielectric thin film 40 further contains the rear earth element, and thus, the DC bias properties of the dielectric thin film 40 are easily improved.

The thickness of the dielectric thin film 40, for example, may be greater than or equal to 0.01 μm and less than or equal to 2 μm (greater than or equal to 10 nm and less than or equal to 2000 nm). However, the thickness of the dielectric thin film 40 is not limited. The thickness of the dielectric thin film 40 may be measured by observing the sectional surface of the thin film capacitor 100 with a scanning electron microscope (SEM). The sectional surface of the thin film capacitor 100 may be formed by drilling the thin film capacitor 100 with a focused ion beam (FIB).

(Substrate)

The composition of the substrate 10 is not limited insofar as the substrate 10 has a mechanical strength at which the cohesive film 20, the lower electrode 30, the dielectric thin film 40, and the upper electrode 50 that are formed on the substrate 10 can be supported. The substrate 10, for example, may be a single crystal substrate, a ceramic polycrystal substrate, or a metal substrate. The single crystal substrate, for example, may consist of Si single crystals, SiGe single crystals, GaAs single crystals, InP single crystals, SrTiO₃ single crystals, MgO single crystals, LaAlO₃ single crystals, ZrO₂ single crystals, MgAl₂O₄ single crystals, or NdGaO₃ single crystals. The ceramic polycrystal substrate, for example, may consist of Al₂O₃ polycrystals, ZnO polycrystals, or SiO₂ polycrystals. The metal substrate, for example, may consist of nickel (Ni), copper (Cu), titanium (Ti), tungsten (W), molybdenum (Mo), aluminum (A), platinum (Pt), an alloy containing such metals, or the like. The Si single crystals are preferable from the viewpoint of a low cost and processing easiness. In a case where the substrate 10 has sufficient conductivity, the dielectric thin film 40 may be directly overlaid on the surface of the substrate, and the substrate 10 may function as an electrode.

The thickness of the substrate 10, for example, may be greater than or equal to 10 μm and less than or equal to 5000 μm. However, the thickness of the substrate 10 is not limited. In a case where the substrate 10 is excessively thin, it is difficult for the substrate 10 to have a sufficient mechanical strength. In a case where the substrate 10 is excessively thick, the thickness of the entire thin film capacitor 100 increases, and thus, it is difficult to mount the thin film capacitor 100 on a small electronic component.

The electrical resistivity of the substrate 10 is different in accordance with the material of the substrate 10. In a case where the electrical resistivity of the substrate 10 is low, a current is leaked to the substrate 10 when the thin film capacitor 100 is operated, and thus, the electric properties of the thin film capacitor 100 are impaired. For example, in a case where the substrate 10 consists of the Si single crystals, there is a possibility that a current is leaked to the substrate 10. Therefore, in a case where the electrical resistivity of the substrate 10 is low, the surface of the substrate 10 may be covered with an insulating film, or the cohesive film 20 or the lower electrode 30 may be overlaid on the surface of the insulating film. The insulating film suppresses a leak current. The composition and the thickness of the insulating film are not limited insofar as the substrate 10 and the capacitor portion 60 are insulated from each other. The insulating film, for example, may consist of SiO₂, Al₂O₃, or Si₃Nₓ. The thickness of the insulating film, for example, may be greater than or equal to 0.01 μm and less than or equal to 10 m. The insulating film is not essential for the thin film capacitor 100. That is, the cohesive film 20 or the lower electrode 30 may be directly overlaid on the surface of the substrate 10.

(Cohesive Film)

The cohesive film 20 is disposed between the substrate 10 and the lower electrode 30, and thus, the peeling of the lower electrode 30 from the substrate 10 is suppressed. The composition of the cohesive film 20 is not limited insofar as the peeling of the lower electrode 30 from the substrate 10 is suppressed. The cohesive film 20, for example, may contain at least one type selected from the group consisting of Cr, Ti, TiO₂, SiO₂, Y₂O₃, and ZrO₂. The cohesive film is not essential for the thin film capacitor 100. In a case where the lower electrode 30 easily directly adheres tightly to the substrate 10 or the insulating film, the lower electrode 30 may be directly overlaid on the substrate 10 or the insulating film.

(Lower Electrode)

The composition of the lower electrode 30 is not limited insofar as the lower electrode 30 has sufficient conductivity. The lower electrode 30, for example, may be platinum (Pt), ruthenium (Ru), rhodium (Rh), palladium (Pd), iridium (Ir), gold (Au), silver (Ag), copper (Cu), nickel (Ni), an alloy containing such metals, or a conductive oxide. The thickness of the lower electrode 30 is not limited insofar as the lower electrode 30 functions as an electrode. The thickness of the lower electrode 30, for example, may be greater than or equal to 0.01 μm and less than or equal to 10 μm.

(Upper Electrode)

The composition of the upper electrode 50 is not limited insofar as the upper electrode 50 has sufficient conductivity. The upper electrode 50, for example, may be platinum (Pt), ruthenium (Ru), rhodium (Rh), palladium (Pd), iridium (r), gold (Au), silver (Ag), copper (Cu), nickel (Ni), an alloy such metals, or a conductive oxide. The thickness of the upper electrode 50 is not limited insofar as the upper electrode 50 functions as an electrode. The thickness of the upper electrode 50, for example, may be greater than or equal to 0.01 μm and less than or equal to 10 μm.

(Protective Layer)

The protective film 70 covers the lower electrode 30, the dielectric thin film 40, and the upper electrode 50, and thus, the lower electrode 30, the dielectric thin film 40, and the upper electrode 50 are blocked from the external atmosphere. As a result thereof, the oxidation of the lower electrode 30 and the upper electrode 50 and the corrosion of the dielectric thin film 40 are suppressed. In addition, the protective film 70 suppresses the breakage of the thin film capacitor. The composition of the protective film 70 is not limited insofar as the protective film 70 has the function described above. The protective film 70, for example, may consist of a thermosetting resin such as an epoxy resin.

(Manufacturing Method of Dielectric Thin Film and Thin Film Capacitor)

The dielectric thin film 40 and the thin film capacitor 100 may be manufactured by the following manufacturing method.

The cohesive film 20 is formed on the surface of the substrate 10 (a main surface), and the lower electrode 30 is formed on the surface of the cohesive film 20. A formation method of each of the cohesive film 20 and the lower electrode 30, for example, may be a sputtering method, a vacuum deposition method, a printing method, a spin coating method, or a sol-gel method.

In a case where the Si single crystal substrate is used as the substrate 10, the insulating film may be formed on the surface of the substrate 10 before the cohesive film 20 and the lower electrode 30 are formed. A formation method of the insulating film, for example, may be a thermal oxidation method or a chemical vapor deposition (CVD) method.

The substrate 10, the cohesive film 20, and the lower electrode 30 may be subjected to a thermal treatment after the lower electrode 30 is formed. The cohesiveness between the cohesive film 20 and the lower electrode 30 is improved by the thermal treatment. A temperature increase rate of the thermal treatment may be preferably greater than or equal to 10° C./minute and less than or equal to 2000° C./minute, and may be more preferably greater than or equal to 100° C./minute and less than or equal to 1000° C./minute. The temperature of the thermal treatment may be preferably higher than or equal to 400° C. and lower than or equal to 800° C. A time for performing the thermal treatment may be preferably longer than or equal to 0.1 hours and shorter than or equal to 4.0 hours. In a case where each condition of the thermal treatment is out of the range described above, it is difficult to improve the cohesiveness between the cohesive film 20 and the lower electrode 30, and it is difficult to make the surface of the lower electrode 30 flat. As a result thereof, the dielectric properties of the dielectric thin film 40 are easily impaired.

Bi, the element E1, the element E2, Ti, and O are deposited on the surface of the lower electrode 30, and thus, the dielectric thin film 40 is formed on the surface of the lower electrode 30. A formation method of the dielectric thin film 40, for example, may be a vacuum deposition method, a sputtering method, a pulsed laser deposition (PLD) method, a metal-organic chemical vapor deposition (MOCVD) method, a metal organic decomposition (MOD) method, a sol-gel method, or a chemical solution deposition (CSD) method. The composition of all raw materials used in the formation method described above may be adjusted to be approximately coincident with Chemical Formula 1a or Chemical Formula 1b described above. [Bi]/[E2] described above may be controlled by adjusting the composition of all of the raw materials. A plurality of types of raw materials may be used. Unless the dielectric properties of the dielectric thin film 40 are impaired, the raw material may contain a trace amount of impurities or accessory components.

In a case where the dielectric thin film 40 is formed by the sputtering method, a target having a composition that is approximately coincident with Chemical Formula 1a or Chemical Formula 1b described above may be prepared. Raw materials of the target are not limited insofar as all of the raw materials of the target contain Bi, the element E1, the element E2, and Ti. The target may be prepared from a plurality of types of raw materials. The raw material of the target, for example, may be at least one type of compound selected from the group consisting of a carbonate, an oxide, and a hydroxide. Powders of each of the compounds are weighed in accordance with the composition of the dielectric thin film 40, and then, the powders of each of the compounds are mixed. A mixing method, for example, may be a ball mill. The powders of each of the compounds may be mixed along with water or an organic solvent. The mixed powder is molded by being pressurized, and thus, a molded body is obtained. A molding pressure, for example, may be greater than or equal to 10 Pa and less than or equal to 200 Pa.

The molded body is burned (sintered) in an oxidative atmosphere, and thus, the target (a sintered body) is obtained. A burning temperature, for example, may be higher than or equal to 900° C. and lower than or equal to 1300° C. A burning time, for example, may be longer than or equal to 1 hour and shorter than or equal to 10 hours. The oxidative atmosphere, for example, may be the atmospheric air. The shape and the dimension of the target may be adjusted by processing the target. The target, for example, may be a disk.

It is preferable that the dielectric thin film 40 is formed by a radio-frequency sputtering method. In the radio-frequency sputtering method, the substrate 10 on which the cohesive film 20 and the lower electrode 30 are laminated is provided in a vacuum chamber. The vacuum chamber is filled with mixed gas of argon (Ar) and oxygen (O₂). A ratio (V1/V2) of a volume VI of Ar to a volume V2 of O₂ may be preferably greater than or equal to 1/1 and less than or equal to 5/1. A radio-frequency voltage may be preferably greater than or equal to 150 W and less than or equal to 1000 W. The radio-frequency voltage is a voltage for applying an alternating voltage between the vacuum chamber (a positive electrode) and the target (a negative electrode). In a case where the radio-frequency voltage is sufficiently large, the twin crystals of the oxide are easily formed. In a case where the radio-frequency voltage is excessively small, it is difficult to form the dielectric thin film 40 containing the twin crystals of the oxide. The temperature of the substrate 10 in the radio-frequency sputtering method may be preferably higher than or equal to a room temperature and lower than or equal to 200° C.

The dielectric thin film 40 may be subjected to a rapid thermal annealing (RTA) treatment after the dielectric thin film 40 is formed. In the RTA, the temperature of the dielectric thin film 40 increases to an annealing temperature T at a temperature increase rate Vt, and then, the dielectric thin film 40 is continuously heated at the annealing temperature T. It is preferable that the temperature increase rate Vt of the RTA is greater than or equal to 300° C./minute and less than or equal to 3000° C./minute. In a case where the temperature increase rate Vt is sufficiently high, the crystals of the oxide in the dielectric thin film 40 is easy to grow rapidly, and a lattice mismatch is easily formed in the crystals of the oxide. As a result thereof, the twin crystals of the oxide are easily formed. It is preferable that the annealing temperature T is higher than or equal to 700° C. and lower than or equal to 1000° C., from the viewpoint of easily forming the twin crystals of the oxide. It is preferable that an annealing time of the dielectric thin film 40 is longer than or equal to 0.5 minutes and shorter than or equal to 5 minutes, from the viewpoint of easily forming the twin crystals of the oxide. The annealing time is a time for which the temperature of the dielectric thin film 40 is maintained at the annealing temperature T. In the RTA, it is preferable that the dielectric thin film 40 is heated in the atmospheric air or the oxidative atmosphere.

The dielectric thin film 40 containing the twin crystals of the oxide is formed by the method described above. As described above, the radio-frequency sputtering method and the RTA are performed in a predetermined condition, and thus, the twin crystals of the oxide are formed. In a thick film method (a sintering method) of the related art, a ceramic thick film is formed by sintering a powder of a dielectric substance, and thus, it is difficult to control the formation of the twin crystals of the oxide by the thick film method (the sintering method).

The upper electrode 50 is formed on the surface of the dielectric thin film 40 after the RTA. The upper electrode 50 may be formed by the same method as that of the lower electrode 30.

The protective film 70 covering the lower electrode 30, the dielectric thin film 40, and the upper electrode 50 may be formed after the upper electrode 50 is formed. A formation method of the protective film 70 is not limited. For example, the protective film 70 may be formed by covering the lower electrode 30, the dielectric thin film 40, and the upper electrode 50 with an uncured thermosetting resin, and then, by heating the thermosetting resin. The protective film 70 may be formed by covering the lower electrode 30, the dielectric thin film 40, and the upper electrode 50 with a semicured material of a thermosetting resin, and then, by heating the semicured material.

A preferred embodiment of the second invention has been described, the second invention is not necessarily limited to the embodiment described above. The second invention can be variously changed within a range not departing from the gist of the second invention, and change examples thereof are also included in the second invention.

For example, the thin film capacitor may further include another dielectric thin film that is laminated on the dielectric thin film 40 described above. Another dielectric thin film, for example, may be an amorphous dielectric thin film such as Si₃Nₓ, SiOₓ, Al₂Oₓ, ZrOₓ, or Ta₂Oₓ. Another dielectric thin film is laminated on the dielectric thin film 40 described above, and thus, the impedance and the temperature properties of the dielectric thin film 40 are easily adjusted. The structure of the thin film capacitor is not limited to a structure illustrated in FIG. 2 insofar as the thin film capacitor includes at least a pair of electrodes, and the dielectric thin film 40 that is disposed between the pair of electrodes.

### Examples of Second Invention

Hereinafter, the second invention will be described in more detail by examples and comparative examples, but the second invention is not limited to such examples.

### Example 31

<Preparation of Target>

A target that is a raw material of a dielectric thin film was prepared by the following solid-phase method.

Powders of each of bismuth oxide, sodium carbonate, strontium carbonate, and titanium oxide were mixed, and thus, a mixed powder was prepared. The powders of each of bismuth oxide, sodium carbonate, strontium carbonate, and titanium oxide were weighed such that the composition of the mixed powder was coincident with Chemical Formula 1A described below. That is, 1-x and x in Chemical Formula 1A were adjusted to values shown in Table 3 described below, and [Bi]/[E2] was a value shown in Table 3 described below. [Bi]/[E2] is defined as described above. [Bi]/[E2] is represented by {(1−x)×0.5}/x, on the basis of x in Chemical Formula 1A.

(1−x)Bi_{0.5}Na_{0.5}TiO₃-xSrTiO₃ (1A)

BNT described below indicates Bi_{0.5}Na_{0.5}TiO₃. ST described below indicates SrTiO₃.

The mixed powder described above and water were mixed for 20 hours by a ball mill, and thus, a slurry was prepared. The slurry was dried at 100° C., and thus, the mixed powder was collected. The mixed powder was molded by a press, and thus, a molded body was obtained. A molding pressure was 100 Pa. The temperature of the mixed powder in the molding was 25° C. A time for pressurizing the mixed powder was 3 minutes.

The molded body was burned in the air, and thus, a sintered body was obtained. A burning temperature was 1100° C. A burning time was 5 hours.

A disk-like target was prepared by processing the sintered body. The sintered body was processed by using a surface grinder and a cylindrical polishing machine. The diameter of the target was 80 mm, and the thickness of the target was 5 mm.

<Preparation of Dielectric Thin Film and Thin Film Capacitor>

A wafer consisting of Si single crystals was used as a substrate. The thickness of the substrate was 500 μm. The substrate was heated in oxidized gas, and thus, an insulating film consisting of SiO₂ was formed on the substrate. The thickness of the insulating film was adjusted to 500 nm.

A cohesive film consisting of Cr was formed on the surface of the substrate (the insulating film) by a sputtering method. The thickness of the cohesive film was adjusted to 20 nm. A lower electrode consisting of Pt was formed on the surface of the cohesive film by a sputtering method. The thickness of the lower electrode was adjusted to 100 nm.

A dielectric thin film was formed on the surface of the lower electrode by a radio-frequency sputtering method using the target described above. In the radio-frequency sputtering method, the substrate on which the insulating film, the cohesive film, and the lower electrode were laminated was provided in a vacuum chamber. The vacuum chamber was filled with mixed gas of Ar and O₂. An atmospheric pressure in the vacuum chamber was maintained at 1.0 Pa. The ratio (V1/V2) of the volume V1 of Ar to the volume V2 of O₂ was 3/1. A radio-frequency voltage was 300 W. The temperature of the substrate 10 in the vacuum chamber was maintained at 100° C. The thickness of the dielectric thin film was adjusted to 300 nm.

The dielectric thin film was subjected to a rapid thermal annealing (RTA) treatment after the dielectric thin film was formed. In the RTA, the dielectric thin film was heated in the atmospheric air. In the RTA, the temperature of the dielectric thin film increased to the annealing temperature T at the temperature increase rate Vt, and then, the dielectric thin film 40 was continuously heated at the annealing temperature T. The temperature increase rate Vt of the RTA was 900° C./minute. The annealing temperature T was 900° C. An annealing time of the dielectric thin film was 1 minute.

After the RTA, an upper electrode consisting of Pt was formed on the surface of the dielectric thin film by a sputtering method. A circular upper electrode was formed by masking. The diameter of the upper electrode was adjusted to 200 μm. The thickness of the upper electrode was adjusted to 100 nm.

The dielectric thin film and a thin film capacitor of Example 31 were prepared by the method described above.

<Analysis of Dielectric Thin Film and Thin Film Capacitor>

[Analysis of Composition and Crystalline Structure of Dielectric Thin Film]

An X-ray diffraction (XRD) pattern of the dielectric thin film of Example 31 was measured. The XRD pattern was measured by using an X-ray diffraction device (SmartLab) manufactured by Rigaku Corporation. The XRD pattern indicated that the dielectric thin film had a perovskite structure.

The composition of the dielectric thin film of Example 31 was analyzed by an X-ray fluorescence (XRF) analysis method. An analysis result indicated that the composition of the dielectric thin film was coincident with the composition represented by Chemical Formula 1A described above, and 1-x and x in Chemical Formula 1A were coincident with the values shown in Table 3 described below.

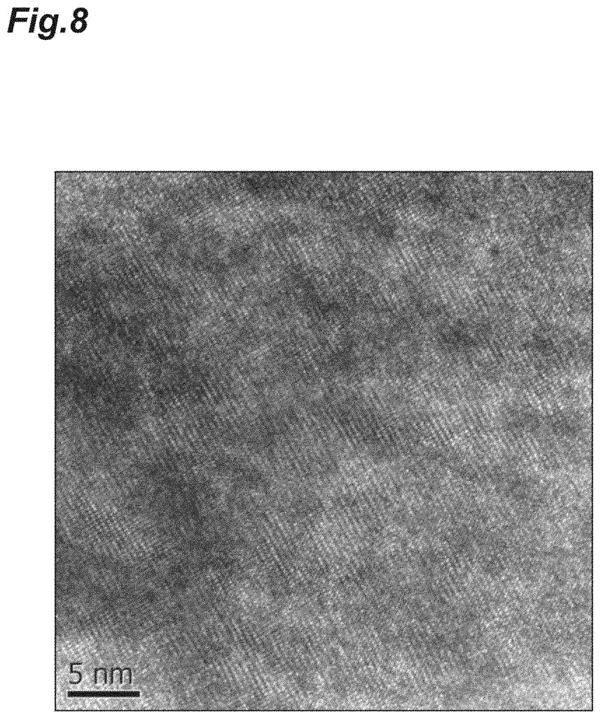

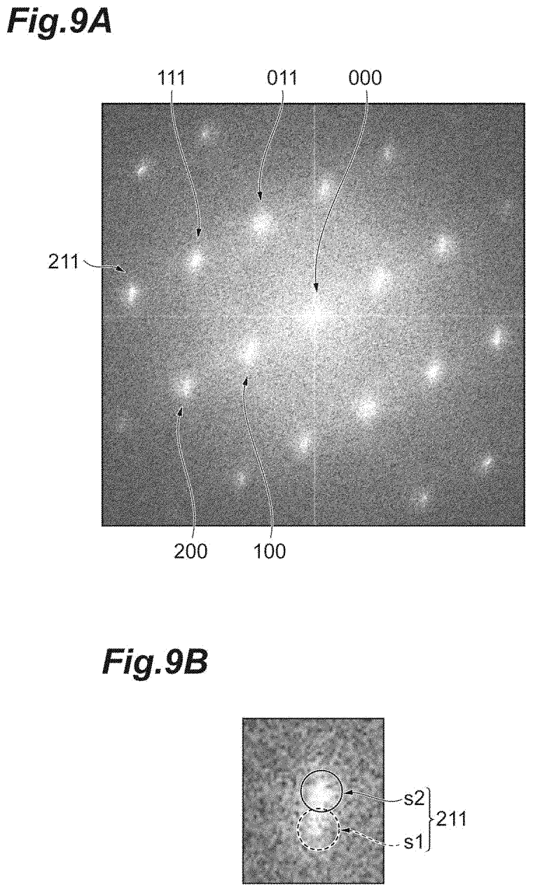

Visual fields of 20 sites of the dielectric thin film of Example 31 were captured by a transmission electron microscope (TEM). The dimension of each of the captured visual fields was a length of 35 nm×a width of 35 nm. Each of 20 images was subjected to fast Fourier transform, and thus, 20 FFT patterns were obtained. Each of the images was subjected to the fast Fourier transform by software (Gatan Microscopy Suite) manufactured by Gatan, Inc. In five FFT patterns of 20 FFT patterns, a spot corresponding to each crystallite orientation was separated into a spot S1 and a spot S2. That is, in five sites of 20 sites, twin crystals were detected. A crystal lattice image of a portion in which the twin crystals are formed is shown in FIG. 8. An FFT pattern corresponding to the crystal lattice image shown in FIG. 8 is shown in FIG. 9A and FIG. 9B. In FIG. 9A, 100, 200, 011, 111, and 211 are respectively indices associated with the crystallite orientation in the perovskite structure. 000 corresponds to an original point for defining the position of each of the spots. FIG. 9B is an enlarged view of the spot St and the spot S2 corresponding to 211 shown in FIG. 9A.

The analysis result described above indicated that the dielectric thin film of Example 31 contained an oxide represented by Chemical Formula 1A described above, the oxide had a perovskite structure, and the oxide contained twin crystals.

[Evaluation of DC Bias Properties]

In a state where a direct-current electric field was not applied to the dielectric thin film, an electrostatic capacitance C1 of the thin film capacitor of Example 31 was measured. A digital LCR meter (4284A) manufactured by Hewlett-Packard Company was used as a measurement device of the electrostatic capacitance. All measurement conditions of the electrostatic capacitance C1 are as follows.

Measurement Temperature: 25° C.

Measurement Frequency: 1 kHz

Input Signal Level (Measurement Voltage): 1.0 Vrms

Intensity of Direct-current electric field (DC Bias): 0 V/m

A relative permittivity εr1 of the dielectric thin film of Example 31 was calculated from the electrostatic capacitance C1, an effective area of the electrode (the area of the upper electrode), a distance between the electrodes, and a vacuum permittivity ε₀. That is, the relative permittivity εr1 of the dielectric thin film in a state where the direct-current electric field was not applied to the dielectric thin film was calculated. εr1 of Example 31 is shown in Table 3 described below. There is no unit of the relative permittivity.

In a state where the direct-current electric field was applied to the dielectric thin film, an electrostatic capacitance C2 of the thin film capacitor of Example 31 was measured. The intensity of the direct-current electric field was 10 V/μm. All measurement conditions of the electrostatic capacitance C2 were identical to all measurement conditions of the electrostatic capacitance C1 except for the intensity of the direct-current electric field. A relative permittivity εr2 of the dielectric thin film of Example 31 was calculated from the electrostatic capacitance C2. That is, the relative permittivity εr2 of the dielectric thin film in a state where the direct-current electric field was applied to the dielectric thin film was calculated. A calculation method of εr2 was identical to a calculation method of εr1 except for the electrostatic capacitance. εr2 of Example 31 is shown in Table 3 described below. It is preferable that εr2 is greater than or equal to 600.

[Evaluation of Temperature Properties]

The thin film capacitor of Example 31 was provided in a thermostatic bath. The electrostatic capacitance of the thin film capacitor at each temperature was continuously measured while continuously changing the temperature of the thin film capacitor in the thermostatic bath to 85° C. from −55° C. All measurement conditions of the electrostatic capacitance at each of the temperatures are as follows.

Measurement Frequency: 1 kfz

Input Signal Level (Measurement Voltage): 1.0 Vrms

Intensity of Direct-current electric field (DC Bias): 0 V/μm

The relative permittivity at each of the temperatures was calculated from the electrostatic capacitance at each of the temperatures. A calculation method of the relative permittivity at each of the temperatures was identical to the calculation method of εr1 except for the electrostatic capacitance. A change rate Δ249 r of the relative permittivity was calculated on the basis of the relative permittivity at each of the temperatures. Δ249 r is defined by Mathematical Expression a described below. The unit of Δεr is %. In Mathematical Expression a, εr(25° C.) is a relative permittivity at 25° C. εr(T) is a relative permittivity at which a difference with respect to εr(25° C.) is maximum in an absolute value, in all of the relative permittivities measured in the temperature range described above. Δ249 r of Example 31 is shown in Table 3 described below. It is preferable that Δ249 r is greater than or equal to −15% and less than or equal to 15%.

Δεr=100×{εr(T)−εr(25° C.)}/εr(25° C.) (a)

### Examples 32 to 34

In the preparation of a target of each of Examples 32 to 34, 1-x and x in Chemical Formula 1A were adjusted to values shown in Table 3 described below, and [Bi]/[E2] was a value shown in Table 3 described below. A dielectric thin film and a thin film capacitor of each of Examples 32 to 34 were prepared by the same method as that in Example 31 except for the composition of the target.

The dielectric thin film and the thin film capacitor of each of Examples 32 to 34 were analyzed by the same method as that in Example 31. In any of Examples 32 to 34, the composition of the dielectric thin film was coincident with the composition represented by Chemical Formula 1A described above, and 1-x and x in Chemical Formula 1A were coincident with values shown in Table 3 described below. In any of Examples 32 to 34, the dielectric thin film contained the oxide represented by Chemical Formula 1A described above, the oxide had a perovskite structure, and the oxide contained twin crystals. εr1, εr2, and Δεr of each of Examples 32 to 34 are shown in Table 3 described below.

### Comparative Example 31

A radio-frequency voltage in a radio-frequency sputtering method of Comparative Example 31 was 100 W. The temperature increase rate Vt of an RTA in Comparative Example 31 was 100° C./minute. An annealing time of the RTA in Comparative Example 31 was 10 minutes. A dielectric thin film and a thin film capacitor of Comparative Example 31 were prepared by the same method as that in Example 33 except for such matters (a formation method of the dielectric thin film).

The dielectric thin film and the thin film capacitor of Comparative Example 31 were analyzed by the same method as that in Example 31. The composition of the dielectric thin film of Comparative Example 31 was coincident with the composition represented by Chemical Formula 1A described above, and 1-x and x in Chemical Formula 1A were coincident with values shown in Table 3 described below. An oxide of Comparative Example 31 had a perovskite structure. However, in an FFT pattern of Comparative Example 31, a spot corresponding to each crystallite orientation was not separated. That is, twin crystals of the oxide were not detected from the dielectric thin film of Comparative Example 31. εr1, εr2, and Δ249 r of Comparative Example 31 are shown in Table 3 described below.

### Example 41

A target of Example 41 was prepared by the following solid-phase method.

Powders of each of bismuth oxide, sodium carbonate, barium carbonate, and titanium oxide were mixed, and thus, a mixed powder was prepared. The powders of each of bismuth oxide, sodium carbonate, barium carbonate, and titanium oxide were weighed such that the composition of the mixed powder was coincident with Chemical Formula 1B described below. That is, 1-x and x in Chemical Formula 1B were adjusted to values shown in Table 4 described below, and [Bi]/[E2] was a value shown in Table 4 described below. [Bi]/[E2] is represented by {(1−x)×0.5}/x, on the basis of x in Chemical Formula 1B. BT described below indicates BaTiO₃.

(1−x)Bi_{0.5}Na_{0.5}TiO₃-xBaTiO₃ (1B)

A dielectric thin film and a thin film capacitor of Example 41 were prepared by the same method as that in Example 31 except for the composition of the target.

The dielectric thin film and the thin film capacitor of Example 41 were analyzed by the same method as that in Example 31. The composition of the dielectric thin film of Example 41 was coincident with the composition of Chemical Formula 1B described above, and 1-x and x in Chemical Formula 1B were coincident with values shown in Table 4 described below. The dielectric thin film of Example 41 contained an oxide represented by Chemical Formula 1B described above, the oxide had a perovskite structure, and the oxide contained twin crystals. εr1, εr2, and Δ249 r of Example 41 are shown in Table 4 described below.

### Example 42

A target of Example 42 was prepared by the following solid-phase method.

Powders of each of bismuth oxide, sodium carbonate, calcium carbonate, and titanium oxide were mixed, and thus, a mixed powder was prepared. The powders of each of bismuth oxide, sodium carbonate, calcium carbonate, and titanium oxide were weighed such that the composition of the mixed powder was coincident with Chemical Formula 1C described below. That is, 1-x and x in Chemical Formula 1C were adjusted to values shown in Table 4 described below, and [Bi]/[E2] was a value shown in Table 4 described below. [Bi]/[E2] is represented by {(1-x)×0.5}/x, on the basis of x in Chemical Formula 1C. CT described below indicates CaTiO₃.

(1−x)Bi_{0.5}Na_{0.5}TiO₃-xCaTiO₃ (1C)

A dielectric thin film and a thin film capacitor of Example 42 were prepared by the same method as that in Example 31 except for the composition of the target.

The dielectric thin film and the thin film capacitor of Example 42 were analyzed by the same method as that in Example 31. The composition of the dielectric thin film of Example 42 was coincident with the composition represented by Chemical Formula 1C described above, and 1-x and x in Chemical Formula 1C were coincident with values shown in Table 4 described below. The dielectric thin film of Example 42 contained an oxide represented by Chemical Formula 1C described above, the oxide had a perovskite structure, and the oxide contained twin crystals. εr1, εr2, and Δ249 r of Example 42 are shown in Table 4 described below.

### Example 43

A target of Example 43 was prepared by the following solid-phase method.

Powders of each of bismuth oxide, potassium carbonate, barium carbonate, and titanium oxide were mixed, and thus, a mixed powder was prepared. The powders of each of bismuth oxide, potassium carbonate, barium carbonate, and titanium oxide were weighed such that the composition of the mixed powder was coincident with Chemical Formula 1D described below. That is, 1-x and x in Chemical Formula 1D were adjusted to values shown in Table 4 described below, and [Bi]/[E2] was a value shown in Table 4 described below. [Bi]/[E2] was represented by {(1−x)×0.5}/x, on the basis of x in Chemical Formula 1D. BKT described below indicates Bi_{0.5}K_{0.5}TiO₃.

(1−x)Bi_{0.5}K_{0.5}TiO₃-xBaTiO₃ (1D)

A dielectric thin film and a thin film capacitor of Example 43 were prepared by the same method as that in Example 31 except for the composition of the target.

The dielectric thin film and the thin film capacitor of Example 43 were analyzed by the same method as that in Example 31. The composition of the dielectric thin film of Example 43 was coincident with the composition represented by Chemical Formula 1D described above, and 1-x and x in Chemical Formula 1D were coincident with values shown in Table 4 described below. The dielectric thin film of Example 43 contained an oxide represented by Chemical Formula 1D described above, the oxide had a perovskite structure, and the oxide contained twin crystals. εr1, εr2, and Δεr of Example 43 are shown in Table 4 described below.

### Example 44

A target of Example 44 was prepared. by the following solid-phase method.

Powdered of each of bismuth oxide, potassium carbonate, strontium carbonate, and titanium oxide were mixed, and thus, a mixed powder was prepared. The powders of each of bismuth oxide, potassium carbonate, strontium carbonate, and titanium oxide were weighed such that the composition of the mixed powder was coincident with Chemical Formula 1E described below. That is, 1-x and x in Chemical Formula 1E were adjusted to values shown in Table 4 described below, and [Bi]/[E2] was a value shown in Table 4 described below. [Bi]/[E2] is represented by {(1−x)×0.5}/x, on the basis of x in Chemical Formula 1E.

(1−x)Bi_{0.5}K_{0.5}TiO₃-xSrTiO₃ (1E)

A dielectric thin film and a thin film capacitor of Example 44 were prepared by the same method as that in Example 31 except for the composition of the target.

The dielectric thin film and the thin film capacitor of Example 44 were analyzed by the same method as that in Example 31. The composition of the dielectric thin film of Example 44 was coincident with the composition represented by Chemical Formula 1E described above, and 1-x and x in Chemical Formula 1E were coincident with values shown in Table 4 described below. The dielectric thin film of Example 44 contained an oxide represented by Chemical Formula 1E described above, the oxide had a perovskite structure, and the oxide contained twin crystals. Fr, εr2, and Δεr of Example 44 are shown in Table 4 described below.

### Example 45

A target of Example 45 was prepared by the following solid-phase method.

Powders of each of bismuth oxide, potassium carbonate, calcium carbonate, and titanium oxide were mixed, and thus, a mixed powder was prepared. The powders of each of bismuth oxide, potassium carbonate, calcium carbonate, and titanium oxide were weighed such that the composition of the mixed powder was coincident with Chemical Formula 1F described below. That is, 1-x and x in Chemical Formula 1F were adjusted to values shown in Table 4 described below, and [Bi]/[E2] was a value shown in Table 4 described below. [Bi]/[E2] is represented by {(1−x)×0.5}/x, on the basis of x in Chemical Formula 1F.

(1−x)Bi_{0.5}K_{0.5}TiO₃-xCaTiO₃ (1F)

A dielectric thin film and a thin film capacitor of Example 45 were prepared by the same method as that in Example 31 except for the composition of the target.

The dielectric thin film and the thin film capacitor of Example 45 were analyzed by the same method as that in Example 31. The composition of the dielectric thin film of Example 45 was coincident with the composition represented by Chemical Formula 1F described above, and 1-x and x in Chemical Formula 1F were coincident with values shown in Table 4 described below. The dielectric thin film of Example 45 contained an oxide represented by Chemical Formula 1F described above, the oxide had a perovskite structure, and the oxide contained twin crystals. εr1, εr2, and Δεr of Example 45 are shown in Table 4 described below.

TABLE 3

| | 1 − x | x | | Twin | ∈r 1 | ∈r 2 | Δ∈r |
|---|---|---|---|---|---|---|---|
| | (BNT) | (ST) | [Bi]/[E2] | crystals | (at 0 V/μm) | (at 10 V/μm) | [%] |
| Example 31 | 0.90 | 0.10 | 4.500 | Present | 730 | 630 | −10 |
| Example 32 | 0.70 | 0.30 | 1.167 | Present | 760 | 670 | −7 |
| Example 33 | 0.50 | 0.50 | 0.500 | Present | 770 | 690 | −9 |
| Example 34 | 0.30 | 0.70 | 0.214 | Present | 750 | 670 | −8 |
| Comparative | 0.70 | 0.30 | 1.167 | Absent | 750 | 640 | −18 |
| Example 31 | | | | | | | |

TABLE 4

| | | | | Twin | ∈r 1 | ∈r 2 | Δ∈r |
|---|---|---|---|---|---|---|---|
| | 1 − x | x | [Bi]/[E2] | crystals | (at 0 V/μm) | (at 10 V/μm) | [%] |
| Example 41 | (BNT) | (BT) | 1.167 | Present | 710 | 670 | −10 |
| | 0.70 | 0.30 | | | | | |
| Example 42 | (BNT) | (CT) | 1.167 | Present | 680 | 630 | −9 |
| | 0.70 | 0.30 | | | | | |
| Example 43 | (BKT) | (BT) | 1.167 | Present | 690 | 640 | −10 |
| | 0.70 | 0.30 | | | | | |
| Example 44 | (BKT) | (ST) | 1.167 | Present | 700 | 650 | −8 |
| | 0.70 | 0.30 | | | | | |
| Example 45 | (BKT) | (CT) | 1.167 | Present | 680 | 630 | −9 |
| | 0.70 | 0.30 | | | | | |

### INDUSTRIAL APPLICABILITY

The dielectric thin film according to the second invention, for example, is used in the thin film capacitor.

### REFERENCE SIGNS LIST OF FIG. 5, FIG. 6, FIG. 7, FIG. 8, FIG. 9A, AND FIG. 9B

uc: unit cell of perovskite structure, tw: twin crystals of oxide.

### Embodiment of Third Invention

Hereinafter, a preferred embodiment of the third invention will be described with reference to the drawings. In the drawings, the same reference numerals are applied to the same constituent. The third invention is not limited to the following embodiment.

A thin film capacitor will be described as an example of an electronic component according to the embodiment of the third invention. However, the electronic component is not limited to the thin film capacitor.

(Structure of Thin Film Capacitor)

FIG. 2 is a sectional surface of the thin film capacitor 100 that is perpendicular to the surface of the dielectric thin film 40. In other words, FIG. 2 is the sectional surface of the thin film capacitor 100 that is parallel to the thickness direction of the dielectric thin film 40. As illustrated in FIG. 2, the thin film capacitor 100 according to the embodiment of the third invention includes the substrate 10, the cohesive film 20 overlaid on the substrate 10, the lower electrode 30 overlaid on the cohesive film 20, the dielectric thin film 40 overlaid on the lower electrode 30, the upper electrode 50 overlaid on the dielectric thin film 40, and the protective film 70 covering the lower electrode 30, the dielectric thin film 40, and the upper electrode 50.

The capacitor portion 60 includes the lower electrode 30, the dielectric thin film 40, and the upper electrode 50. The lower electrode 30 and the upper electrode 50 are connected to an external circuit. A voltage is applied to the dielectric thin film 40 that is positioned between the lower electrode 30 and the upper electrode 50, and thus, dielectric polarization of the dielectric thin film 40 occurs, and a charge is accumulated in the capacitor portion 60.

The thin film capacitor 100, for example, may be in the shape of a rectangular parallelepiped. However, the shape and the dimension of the entire thin film capacitor are not limited.

(Dielectric Thin Film)

The dielectric thin film 40 according to the embodiment of the third invention contains an oxide having a perovskite structure. The oxide contains bismuth (Bi), the element E1, the element E2, and titanium (Ti). The element E1 is at least one alkali metal element selected from the group consisting of sodium (Na) and potassium (K). The element E2 is at least one alkali earth metal element selected from the group consisting of calcium (Ca), strontium (Sr), and barium (Ba).

The dielectric thin film 40 according to the embodiment of the third invention is more excellent in DC bias properties than the dielectric thin film of the related art. The DC bias properties are properties in which it is difficult for a relative permittivity to decrease in accordance with an increase in the intensity of a direct-current electric field to be applied to the dielectric thin film 40. The following description relevant to the DC bias properties of the dielectric thin film 40 includes a hypothesis or a theoretic speculation. The reason that the DC bias properties of the dielectric thin film 40 are improved is not necessarily limited to the following mechanism.

Dielectric properties of the oxide having a perovskite structure are caused by the displacement of ions of each element configuring the oxide at a voltage. A displacement amount of each of the ions is saturated in accordance with an increase in a voltage, and thus, a relative permittivity of the oxide easily decreases. Even in a case where the intensity of the voltage is the same, the vibration of each of the ions configuring the oxide decreases due to the application of a direct voltage. However, in the case of the embodiment of the third invention, Bi, the element E1, and the element E2, configuring the oxide, are different from each other in an atom radius or an ion radius. Therefore, Bi, the element E1, and the element E2 are disposed on the site A, and thus, there is a spatial room in the perovskite structure. As a result thereof, Ti is easily moved in the perovskite structure, and the dielectric thin film 40 is easily polarized, and thus, the DC bias properties of the dielectric thin film 40 are improved. In other words, the intensity of the direct-current electric field at which the ion displacement amount of Ti or the like is saturated is increased by a combination of Bi, the element E1, and the element E2. As described below, in a case where [Bi]/[E2] is greater than or equal to 0.214 and less than or equal to 4.500, the DC bias properties are easily improved by the mechanism described above.

In a case where the oxide having a perovskite structure contains Bi, the element E1, and Ti, but does not contain the element E2, a Curie point of the oxide is approximately 300° C. However, the oxide further contains the element E2, in addition to Bi, the element E1, and Ti, and thus, the Curie point of the oxide is close to a room temperature. As a result thereof, an absolute value of the relative permittivity of the oxide increases and the relative permittivity of the oxide also increases in the direct-current electric field.

In order to downsize an electronic device on which the thin film capacitor 100 is mounted, it is desirable to make the dielectric thin film 40 thinner. In addition, in order to increase an electrostatic capacitance of the thin film capacitor 100, it is also desirable to make the dielectric thin film 40 thinner. However, even in a case where a direct voltage to be applied to the dielectric thin film 40 is constant, the intensity of the direct-current electric field on the dielectric thin film 40 increases in accordance with a decrease in the thickness of the dielectric thin film 40. A relative permittivity of the dielectric thin film 40 easily decreases in accordance with an increase in the intensity of the direct-current electric field. However, the dielectric thin film 40 according to the embodiment of the third invention is more excellent in the DC bias properties than the dielectric thin film of the related art. As a result thereof, even in a case where the thickness of the dielectric thin film 40 is less than that of the dielectric thin film of the related art, a decrease in the relative permittivity of the dielectric thin film 40 is suppressed.

The dielectric thin film 40 contains tetragonal crystals of the oxide described above and rhombohedral crystals of the oxide described above. The dielectric thin film 40 may substantially consist of only the tetragonal crystals of the oxide described above and the rhombohedral crystals of the oxide described above. The dielectric thin film 40 may further have other crystal phases, in addition to the tetragonal crystals and the rhombohedral crystals. For example, the dielectric thin film 40 may further contain cubic crystals of the oxide described above, in addition to the tetragonal crystals and the rhombohedral crystals. The dielectric thin film 40 may further include a structure gradient region (SGR), in addition to the tetragonal crystals and the rhombohedral crystals. Generally, the structure gradient region is a region (a layer) that exists in the vicinity of an interface on which two crystal phases having different crystalline structures are joined to each other. A lattice constant is gradually changed in the structure gradient region, and thus, a lattice mismatch between two crystal phases is resolved, and a stress due to the lattice mismatch is relaxed. In the embodiment of the third invention, the structure gradient region is a region that exists in the vicinity of an interface on which the tetragonal crystals and the rhombohedral crystals are joined to each other.

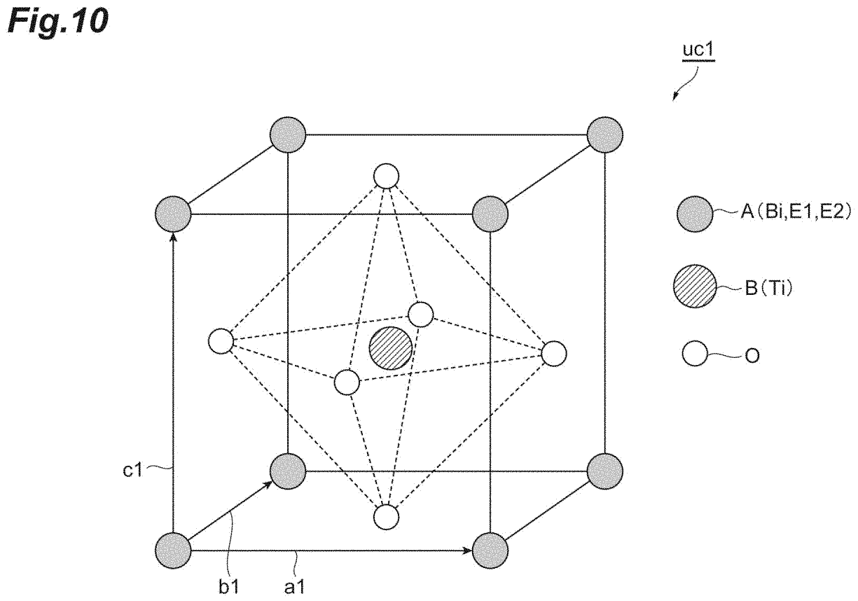

The tetragonal crystals of the oxide having a perovskite structure are illustrated in FIG. 10. A unit cell uc1 of the tetragonal crystals may consist of an element that is positioned on the site A, an element that is positioned on the site B, and oxygen (O). The element that is positioned on the site A may be at least one type selected from the group consisting of Bi, the element E1, and the element E2. The element that is positioned on the site B may be Ti. In FIG. 10, a1, b1, and c1 are basic vectors configuring the tetragonal crystals. The lengths of each of at, b, and c1 are lattice constants of the tetragonal crystals in the direction of each of the vectors. The length of a1 is identical to the length of b1. The length of c1 is greater than the length of a1. That is, the length of c1 is greater than the length of b1.

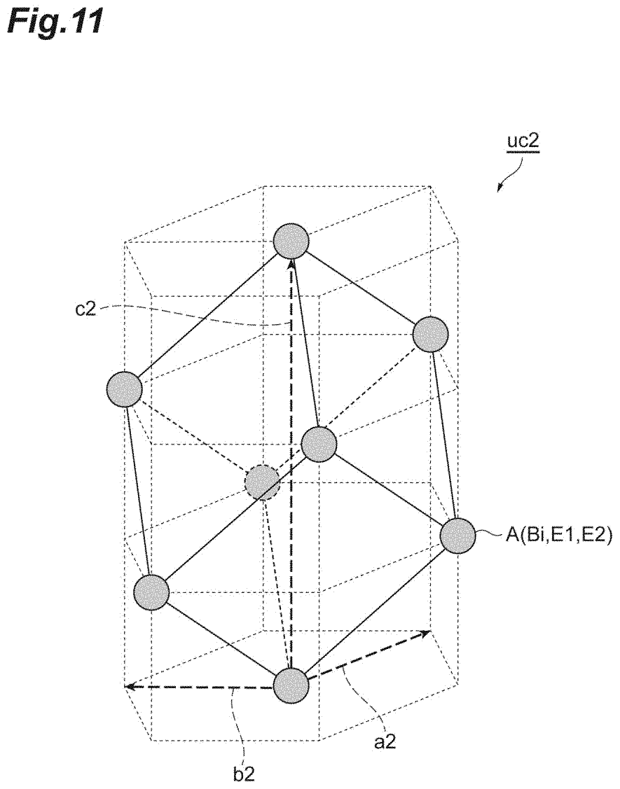

The rhombohedral crystals of the oxide having a perovskite structure are illustrated in FIG. 11. A unit cell uc2 of the rhombohedral crystals may consist of an element that is positioned on the site A, an element that is positioned on the site B, and oxygen (O). For the convenience of drawing, the site B and O are not illustrated in FIG. 11. The element that is positioned on the site A may be at least one type selected from the group consisting of Bi, the element E1, and the element E2. The element that is positioned on the site B may be Ti. In FIG. 11, a2, b2, and c2 are basic vectors configuring the rhombohedral crystals. c2 corresponds to a three-fold rotation axis of the unit cell uc2. That is, the rhombohedral crystals have three-fold rotational symmetry. In a case where basic vectors configuring the cubic crystals of the oxide described above are a3, b3, and c3, [111] (a crystallite orientation) based on a3, b3, and c3 of the cubic crystals corresponds to [001] based on a2, b2, and c2 of the rhombohedral crystals.

In a case where the dielectric thin film 40 does not contain one of the tetragonal crystals and the rhombohedral crystals, a phase transition of the oxide easily occurs in accordance with a temperature change. The relative permittivity of the dielectric thin film 40 is easily changed due to the phase transition. However, the dielectric thin film 40 contains both of the tetragonal crystals and the rhombohedral crystals, and thus, the structure gradient region is formed in the vicinity of the interface between the tetragonal crystals and the rhombohedral crystals. The structure gradient region suppresses rapid progress of the phase transition of the oxide. For example, a rapid phase transition to the tetragonal crystals from the rhombohedral crystals is suppressed. Alternatively, a rapid phase transition to the rhombohedral crystals from the tetragonal crystals is suppressed. Such phase transitions are suppressed, and thus, a change in the relative permittivity of the dielectric thin film 40 according to a temperature change is suppressed. That is, the dielectric thin film 40 contains both of the tetragonal crystals and the rhombohedral crystals, and thus, it is possible for the dielectric thin film 40 to have excellent temperature properties. However, the reason that the temperature properties are improved is not necessarily limited to the mechanism described above.

It is possible to check whether or not the dielectric thin film 40 contains the tetragonal crystals and the rhombohedral crystals, on the basis of an X-ray diffraction (XRD) pattern of the dielectric thin film 40. In a case where the XRD pattern of the dielectric thin film 40 has a peak at a diffraction angle that is peculiar to the tetragonal crystals, the dielectric thin film 40 contains the tetragonal crystals. In a case where the XRD pattern of the dielectric thin film 40 has a peak at a diffraction angle that is peculiar to the rhombohedral crystals, the dielectric thin film 40 contains the rhombohedral crystals.

As described below, the dielectric thin film 40 according to the embodiment of the third invention has characteristics relevant to the XRD pattern.

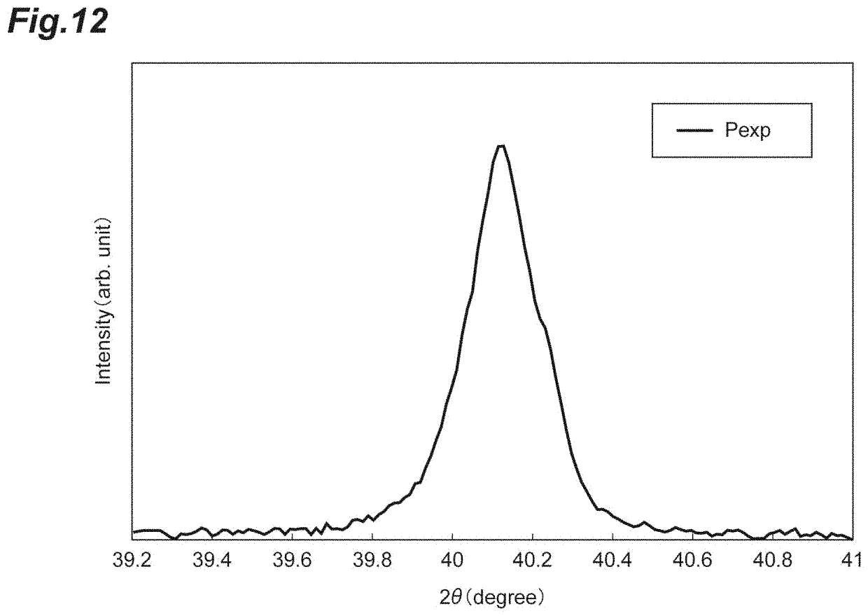

The XRD pattern of the dielectric thin film 40 is measured by using a CuKα ray as an incident X-ray. The unit of the intensity of the diffraction X-ray may be an arbitrary unit. The measurement of the XRD pattern of the dielectric thin film 40 may be out of plane measurement on the surface of the dielectric thin film 40. The XRD pattern of the dielectric thin film 40 has a peak Pexp having the diffraction angle 2θ of greater than or equal to 39.0° and less than or equal to 41.2°. That is, the XRD pattern has the peak Pexp in a range where the diffraction angle 2θ is greater than or equal to 39.0° and less than or equal to 41.2°. The diffraction angle 2θ of the peak Pexp may be greater than or equal to 39.8° and less than or equal to 40.4°. An example of the peak Pexp is shown in FIG. 12.

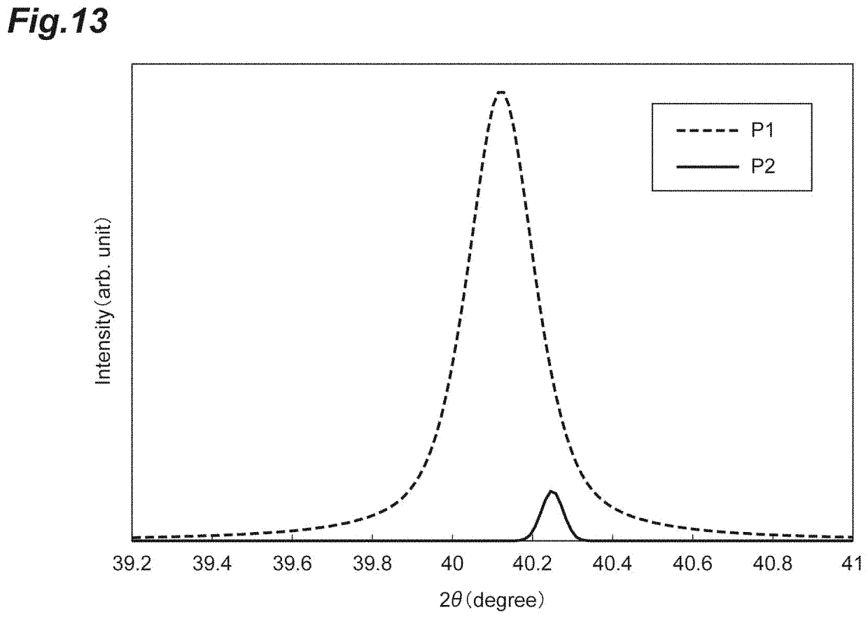

The peak Pexp described above is represented by the superposition of a first peak P1 and a second peak P2. In other words, it is possible to separate the peak Pexp into the first peak P1 and the second peak P2. A diffraction angle 2θ₁ of the first peak P1 is less than a diffraction angle 2θ₂ of the second peak P2. The diffraction angle 2θ₁ of the first peak P1 is approximately greater than or equal to 39.4° and less than or equal to 40.4°. The diffraction angle 2θ₂ of the second peak P2 is approximately greater than or equal to 39.8° and less than or equal to 40.8°. An example of each of the first peak P1 and the second peak P2 is shown in FIG. 13. The peak Pexp may be separated into the first peak P1 and the second peak P2 by the following method.

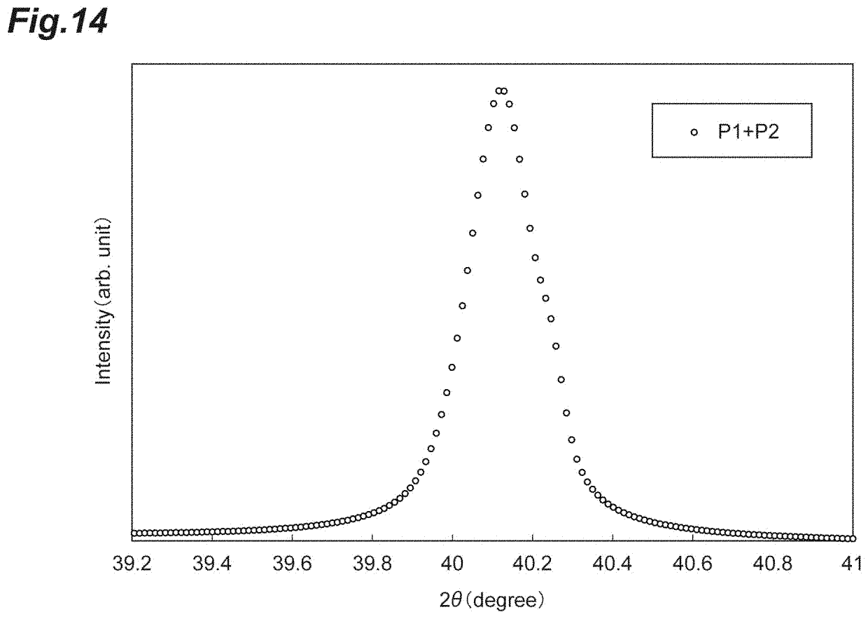

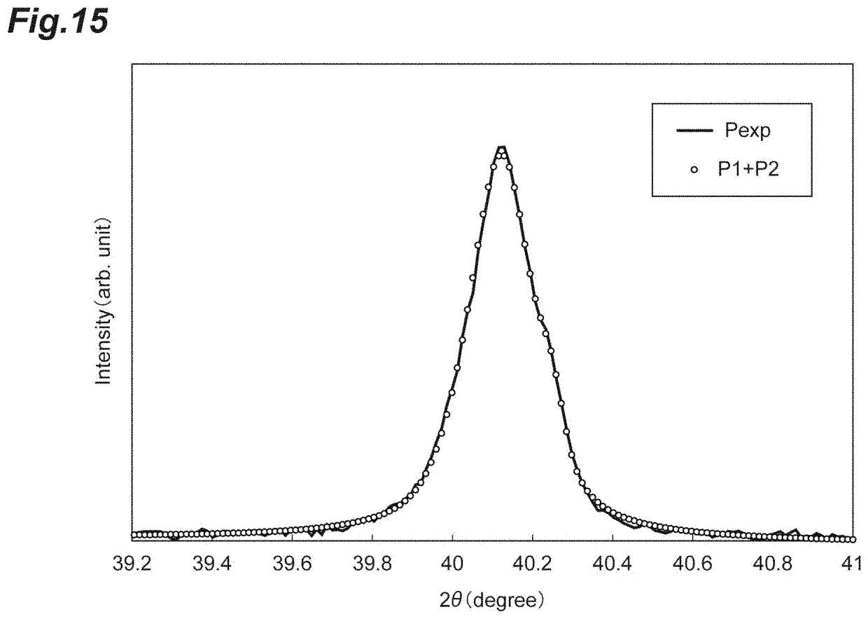

The first peak P1 may be approximated by a Voigt function f1. The second peak P2 may be approximated by another Voigt function f2. The measured peak Pexp, and f1 and f2 are subjected to curve fitting. That is, the measured peak Pexp is approximated by f1+C. f1 after the curve fitting corresponds to the first peak P1. f2 after the curve fitting corresponds to the second peak P2. A peak P1+P2 that is the superposition of the first peak P1 and the second peak P2 is shown in FIG. 14. As shown in FIG. 15, the peak P1+P2 that is obtained by the curve fitting is approximately coincident with the measured peak Pexp. Each of the first peak P1 and the second peak P2 may be approximated by a Lorentzian function instead of the Voigt function. The first peak P1 and the second peak P2 may be approximated by a Gaussian function instead of the Voigt function. The measured peak Pexp is separated into the first peak P1 and the second peak P2 by the method described above.

An area S1 of the first peak P1 is calculated by the integration of the first peak P1. An area S2 of the second peak P2 is calculated by the integration of the second peak P2. S1/S2 is greater than or equal to 0.02 and less than or equal to 55. S1/S2 is greater than or equal to 0.02 and less than or equal to 55, and thus, the temperature properties of the dielectric thin film 40 are improved. It is preferable that S1/S2 is greater than or equal to 0.02 and less than or equal to 50, from the viewpoint of more easily improving the temperature properties of the dielectric thin film 40.

The first peak P1 may be derived from the tetragonal crystals of the oxide described above, and the second peak P2 may be derived from the rhombohedral crystals of the oxide described above. The first peak P1 may be a peak of a diffraction X-ray of a (111) plane of the tetragonal crystals. The (111) plane of the tetragonal crystals is defined on the basis of the basic vectors (a1, b1, and c1) of the tetragonal crystals described above. The second peak P2 may be a peak of a diffraction X-ray of a (003) plane of the rhombohedral crystals. The (003) plane of the rhombohedral crystals is defined on the basis of the basic vectors (a2, b2, and c2) of the rhombohedral crystals described above.

In a case where the first peak P1 is derived from the tetragonal crystals, and the second peak P2 is derived from the rhombohedral crystals, it is possible to confirm whether or not the dielectric thin film 40 contains the tetragonal crystals and the rhombohedral crystals, by separating the peak Pexp and by calculating S1/S2. For example, in a case where S1 is zero and S1/S2 is zero, the dielectric thin film 40 does not contain the tetragonal crystals, but contains the rhombohedral crystals. In a case where S2 is noticeably small and S1/S2 is divergent to infinity, the dielectric thin film 40 contains the tetragonal crystals, but does not substantially contain the rhombohedral crystals. The tetragonal crystals in the dielectric thin film 40 increase and the rhombohedral crystals in the dielectric thin film 40 decrease, as S1/S2 increases. The tetragonal crystals in the dielectric thin film 40 decrease and the rhombohedral crystals in the dielectric thin film 40 increase, as S1/S2 decreases.

The content of Bi in the dielectric thin film 40 may be represented by [Bi] mol %. The unit of [Bi] may be atom %. A sum of the contents of the elements E2 in the dielectric thin film 40 may be represented by [E2] mol %. The unit of [E2] may be atom %. [Bi]/[E2] may be preferably greater than or equal to 0.214 and less than or equal to 4.500. The [Bi]/[E2] is in the range described above, and thus, the temperature properties and the DC bias properties of the dielectric thin film 40 are easily improved.

The composition of the oxide contained in the dielectric thin film 40 may be represented by Chemical Formula 1a or Chemical Formula 1b described below. x, α, β, s, t, and u described in Chemical Formula 1a and Chemical Formula 1b are real numbers. The unit of each of x, α, β, s, t, and u is mol. Both of Chemical Formula 1a and Chemical Formula 1b satisfy all inequalities 2 to 9 described below.

(1−x)Bi_{1-α-β}Na_{α}K_{β}TiO₃-xCaₛSrₜBaᵤTiO₃ <Chemical Formula 1a>

(Bi_{1-α-β}Na_{α}K_{β})₁₋ₓ(CaₛSrₜBaᵤ)ₓTiO₃ <Chemical Formula 1b>

0<x<1 (2)

0.4<α+β<0.6 (3)

0≤α<0.6 (4)

0≤β<0.6 (5)

0.9<s+t+u≤1.1 (6)

0≤s≤1.1 (7)

0≤t≤1.1 (8)

0≤u≤1.1 (9)

The oxide described above may be a main component of the dielectric thin film 40. In a case where the composition of the oxide contained in the dielectric thin film 40 is represented by Chemical Formula 1a or Chemical Formula 1b described above, the content of the oxide in the dielectric thin film 40 may be greater than or equal to 70 mol % and less than or equal to 100 mol %. Unless the perovskite structure of the oxide is impaired, the dielectric thin film 40 may contain other elements, in addition to Bi, the element E1, the element E2, Ti, and O. That is, the dielectric thin film 40 may contain accessory components and a trace amount of impurities, in addition to the oxide described above. For example, the dielectric thin film 40 may further contain at least one type of element of chromium (Cr) and molybdenum (Mo). The dielectric thin film 40 may further contain at least one type of rear earth element selected from the group consisting of scandium (Sc), yttrium (Y), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu). The dielectric thin film 40 further contains the rear earth element, and thus, the DC bias properties of the dielectric thin film 40 are easily improved.

The thickness of the dielectric thin film 40, for example, may be greater than or equal to 0.01 μm and less than or equal to 2 μm (greater than or equal to 10 nm and less than or equal to 2000 nm). However, the thickness of the dielectric thin film 40 is not limited. The thickness of the dielectric thin film 40 may be measured by observing the sectional surface of the thin film capacitor 100 with a scanning electron microscope (SEM). The sectional surface of the thin film capacitor 100 may be formed by drilling the thin film capacitor 100 with a focused ion beam (FIB).

(Substrate)

The composition of the substrate 10 is not limited insofar as the substrate 10 has a mechanical strength at which the cohesive film 20, the lower electrode 30, the dielectric thin film 40, and the upper electrode 50 that are formed on the substrate 10 can be supported. The substrate 10, for example, may be a single crystal substrate, a ceramic polycrystal substrate, or a metal substrate. The single crystal substrate, for example, may consist of Si single crystals, SiGe single crystals, GaAs single crystals, InP single crystals, SrTiO₃ single crystals, MgO single crystals, LaAlO₃ single crystals, ZrO₂ single crystals, MgAl₂O₄ single crystals, or NdGaO₃ single crystals. The ceramic polycrystal substrate, for example, may consist of Al₂O₃ polycrystals, ZnO polycrystals, or SiO₂ polycrystals. The metal substrate, for example, may consist of nickel (Ni), copper (Cu), titanium (Ti), tungsten (W), molybdenum (Mo), aluminum (Al), platinum (Pt), an alloy containing such metals, or the like. The Si single crystals are preferable from the viewpoint of a low cost and processing easiness. In a case where the substrate 10 has sufficient conductivity, the dielectric thin film 40 may be directly overlaid on the surface of the substrate, and the substrate 10 may function as an electrode.

The thickness of the substrate 10, for example, may be greater than or equal to 10 μm and less than or equal to 5000 μm. However, the thickness of the substrate 10 is not limited. In a case where substrate 10 is excessively thin, it is difficult for the substrate 10 to have a sufficient mechanical strength. In a case where the substrate 10 is excessively thick, the thickness of the entire thin film capacitor 100 increases, and thus, it is difficult to mount the thin film capacitor 100 on a small electronic component.

The electrical resistivity of the substrate 10 is different in accordance with the material of the substrate 10. In a case where the electrical resistivity of the substrate 10 is low, a current is current leaked to the substrate 10 when the thin film capacitor 100 is operated, and thus, the electric properties of the thin film capacitor 100 are impaired. For example, in a case where the substrate 10 consists of the Si single crystals, there is a possibility that a current is leaked to the substrate 10. Therefore, in a case where the electrical resistivity of the substrate 10 is low, the surface of the substrate 10 may be covered with an insulating film, or the cohesive film 20 or the lower electrode 30 may be overlaid on the surface of the insulating film. The insulating film suppresses a leak current. The composition and the thickness of the insulating film are not limited insofar as the substrate 10 and the capacitor portion 60 are insulated from each other. The insulating film, for example, may consist of SiO₂, Al₂O₃ or Si₃Nₓ. The thickness of the insulating film, for example, may be greater than or equal to 0.01 μm and less than or equal to 10 μm. The insulating film is not essential for the thin film capacitor 100. That is, the cohesive film 20 or the lower electrode 30 may be directly overlaid on the surface of the substrate 10.

(Cohesive Film)

The cohesive film 20 is disposed between the substrate 10 and the lower electrode 30, and thus, the peeling of the lower electrode 30 from the substrate 10 is suppressed. The composition of the cohesive film 20 is not limited insofar as the peeling of the lower electrode 30 from the substrate 10 is suppressed. The cohesive film 20, for example, may contain at least one type selected from the group consisting of Cr, Ti, TiO₂, SiO₂, Y₂O₃, and ZrO₂. The cohesive film is not essential for the thin film capacitor 100. In a case where the lower electrode 30 easily directly adheres tightly to the substrate 10 or the insulating film, the lower electrode 30 may be directly overlaid on the substrate 10 or the insulating film.

(Lower Electrode)

The composition of the lower electrode 30 is not limited insofar as the lower electrode 30 has sufficient conductivity. The lower electrode 30, for example, may be platinum (Pt), ruthenium (Ru), rhodium (Rh), palladium (Pd), iridium (Ir), gold (Au), silver (Ag), copper (Cu), nickel (Ni), an alloy containing such metals, or a conductive oxide. The thickness of the lower electrode 30 is not limited insofar as the lower electrode 30 functions as an electrode. The thickness of the lower electrode 30, for example, may be greater than or equal to 0.01 μm and less than or equal to 10 km.

(Upper Electrode)

The composition of the upper electrode 50 is not limited insofar as the upper electrode 50 has sufficient conductivity. The upper electrode 50, for example, may be platinum (Pt), ruthenium (Ru), rhodium (Rh), palladium (Pd), iridium (Ir), gold (Au), silver (Ag), copper (Cu), nickel (Ni), an alloy containing such metals, or a conductive oxide. The thickness of the upper electrode 50 is not limited insofar as the upper electrode 50 functions as an electrode. The thickness of the upper electrode 50, for example, may be greater than or equal to 0.01 μm and less than or equal to 10 m.

(Protective Layer)

The protective film 70 covers the lower electrode 30, the dielectric thin film 40, and the upper electrode 50, and thus, the lower electrode 30, the dielectric thin film 40, and the upper electrode 50 are blocked from the external atmosphere. As a result thereof, the oxidation of the lower electrode 30 and the upper electrode 50 and the corrosion of the dielectric thin film 40 are suppressed. In addition, the protective film 70 suppresses the breakage of the thin film capacitor. The composition of the protective film 70 is not limited insofar as the protective film 70 has the function described above. The protective film 70, for example, may consist of a thermosetting resin such as an epoxy resin.

(Manufacturing Method of Dielectric Thin Film and Thin Film Capacitor)

The dielectric thin film 40 and the thin film capacitor 100 may be manufactured by the following manufacturing method.

The cohesive film 20 is formed on the surface (a main surface) of the substrate 10, and the lower electrode 30 is formed on the surface of the cohesive film 20. A formation method of each of the cohesive film 20 and the lower electrode 30, for example, may be a sputtering method, a vacuum deposition method, a printing method, a spin coating method, or a sol-gel method.

In a case where the Si single crystal substrate is used as the substrate 10, the insulating film may be formed on the surface of the substrate 10 before the cohesive film 20 and the lower electrode 30 are formed. A formation method of the insulating film, for example, may be a thermal oxidation method or a chemical vapor deposition (CVD) method.

The substrate 10, the cohesive film 20, and the lower electrode 30 may be subjected to a thermal treatment after the lower electrode 30 is formed. The cohesiveness between the cohesive film 20 and the lower electrode 30 is improved by the thermal treatment. A temperature increase rate of the thermal treatment may be preferably greater than or equal to 10° C./minute and less than or equal to 2000° C./minute, and may be more preferably greater than or equal to 100° C./minute and less than or equal to 1000° C./minute. The temperature of the thermal treatment may be preferably higher than or equal to 400° C. and lower than or equal to 800° C. A time for performing the thermal treatment may be preferably longer than or equal to 0.1 hours and shorter than or equal to 4.0 hours. In a case where each condition of the thermal treatment is out of the range described above, it is difficult to improve the cohesiveness between the cohesive film 20 and the lower electrode 30, and it is difficult to make the surface of the lower electrode 30 flat. As a result thereof, the dielectric properties of the dielectric thin film 40 are easily impaired.

Bi, the element E1, the element E2, Ti, and O are deposited on the surface of the lower electrode 30, and thus, the dielectric thin film 40 is formed on the surface of the lower electrode 30. A formation method of the dielectric thin film 40, for example, may be a vacuum deposition method, a sputtering method, a pulsed laser deposition (PLD) method, a metal-organic chemical vapor deposition (MOCVD) method, a metal organic decomposition (MOD) method, a sol-gel method, or a chemical solution deposition (CSD) method. The composition of all raw materials used in the formation method described above may be adjusted to be approximately coincident with Chemical Formula 1a or Chemical Formula 1b described above. [Bi]/[E2] described above may be controlled by adjusting the composition of all of the raw materials. A plurality of types of raw materials may be used. Unless the dielectric properties of the dielectric thin film 40 are impaired, the raw material may contain a trace amount of impurities or accessory components.

In a case where the dielectric thin film 40 is formed by the sputtering method, a target having a composition that is approximately coincident with Chemical Formula 1a or Chemical Formula 1b described above may be prepared. Raw materials of the target are not limited insofar as all of the raw materials of the target contain Bi, the element E1, the element E2, and Ti. The target may be prepared from a plurality of types of raw materials. The raw material of the target, for example, may be at least one type of compound selected from the group consisting of a carbonate, an oxide, and a hydroxide. Powders of each of the compounds are weighed in accordance with the composition of the dielectric thin film 40, and then, the powders of each of the compounds are mixed. A mixing method, for example, may be a ball mill. The powders of each of the compounds may be mixed along with water or an organic solvent. The mixed powder is molded by being pressurized, and thus, a molded body is obtained. A molding pressure, for example, may be greater than or equal to 10 Pa and less than or equal to 200 Pa.

The molded body is burned (sintered) in an oxidative atmosphere, and thus, the target (a sintered body) is obtained. A burning temperature, for example, may be higher than or equal to 900° C. and lower than or equal to 1300° C. A burning time, for example, may be longer than or equal to 1 hour and shorter than or equal to 10 hours. The oxidative atmosphere, for example, may be the atmospheric air. The shape and the dimension of the target may be adjusted by processing the target. The target, for example, may be a disk.

It is preferable that the dielectric thin film 40 is formed by a radio-frequency sputtering method. In the radio-frequency sputtering method, the substrate 10 on which the cohesive film 20 and the lower electrode 30 are laminated is provided in a vacuum chamber. The vacuum chamber is filled with mixed gas of argon (Ar) and oxygen (O₂). The ratio (V1/V2) of the volume V1 of Ar to the volume V2 of O₂ may be preferably greater than or equal to 1/1 and less than or equal to 5/1. A radio-frequency voltage may be preferably greater than or equal to 100 W and less than or equal to 300 W. The radio-frequency voltage is a voltage for applying an alternating voltage between the vacuum chamber (a positive electrode) and the target (a negative electrode). A temperature Tsub of the substrate 10 in the radio-frequency sputtering method is preferably higher than or equal to a room temperature and lower than or equal to 200° C. or is preferably higher than or equal to 100° C. and lower than or equal to 200° C. In a case where the temperature Tsub of the substrate 10 in the radio-frequency sputtering method is excessively high, it is difficult for the tetragonal crystals of the oxide having a perovskite structure to be formed in the dielectric thin film 40, and S1/S2 is likely to be less than 0.02. For example, in a case where the temperature Tsub of the substrate 10 is higher than or equal to 300° C., only the rhombohedral crystals of the oxide having a perovskite structure are easily formed in the dielectric thin film 40, and S1/S2 is approximately zero.

The dielectric thin film 40 may be subjected to a rapid thermal annealing (RTA) treatment after the dielectric thin film 40 is formed. In the RTA, the temperature of the dielectric thin film 40 increases to the annealing temperature T at the temperature increase rate Vt, and then, the dielectric thin film 40 is continuously heated at the annealing temperature T. The dielectric thin film 40 is heated at the annealing temperature T, and then, the dielectric thin film 40 is cooled to a room temperature at a temperature decrease rate Vt′. The temperature increase rate Vt of the RTA may be greater than or equal to 100° C./minute and less than or equal to 3000° C./minute. The annealing temperature T may be higher than or equal to 700° C. and lower than or equal to 1000° C. The annealing time of the dielectric thin film 40 may be longer than or equal to 0.5 minutes and shorter than or equal to 120 minutes. The annealing time is a time for which the temperature of the dielectric thin film 40 is maintained at the annealing temperature T. It is preferable that the temperature decrease rate Vt′ of the RTA is greater than or equal to 600° C./minute and less than or equal to 800° C./minute. In a case where the temperature decrease rate Vt′ is excessively high, it is difficult for the rhombohedral crystals of the oxide having a perovskite structure to be formed in the dielectric thin film 40, and S1/S2 is likely to be a value that is greater than 55. For example, in a case where the temperature decrease rate Vt′ is greater than or equal to 1000° C./minute, only the tetragonal crystals of the oxide having a perovskite structure are easily formed in the dielectric thin film 40, and S1/S2 is easily divergent to infinity. In the RTA, it is preferable that the dielectric thin film 40 is heated in the atmospheric air or the oxidative atmosphere.

The dielectric thin film 40 is formed by the method described above. As described above, the radio-frequency sputtering method and the RTA are performed in a predetermined condition, and thus, the tetragonal crystals and the rhombohedral crystals are formed, and S1/S2 is controlled in a range of greater than or equal to 0.02 and less than or equal to 55. In a thick film method (a sintering method) of the related art, a ceramic thick film is formed by sintering a powder of a dielectric substance, and thus, it is difficult to control the crystalline structure of the dielectric thin film 40 and S1/S2 by the thick film method (the sintering method).

The upper electrode 50 is formed on the surface of the dielectric thin film 40 after the RTA. The upper electrode 50 may be formed by the same method as that of the lower electrode 30.

The protective film 70 covering the lower electrode 30, the dielectric thin film 40, and the upper electrode 50 may be formed after the upper electrode 50 is formed. A formation method of the protective film 70 is not limited. For example, the protective film 70 may be formed by covering the lower electrode 30, the dielectric thin film 40, and the upper electrode 50 with an uncured thermosetting resin, and then, by heating the thermosetting resin. The protective film 70 may be formed by covering the lower electrode 30, the dielectric thin film 40, and the upper electrode 50 with a semicured material of a thermosetting resin, and then, by heating the semicured material.

A preferred embodiment of the third invention has been described, but the third invention is not necessarily limited to the embodiment described above. The third invention can be variously changed within a range not departing from the gist of the third invention, and change examples thereof are also included in the third invention.

For example, the thin film capacitor may further include another dielectric thin film that is laminated on the dielectric thin film 40 described above. Another dielectric thin film, for example, may be an amorphous dielectric thin film such as Si₃Nₓ, SiOₓ, Al₂Oₓ, ZrOₓ, or Ta₂O_{X}. Another dielectric thin film is laminated on the dielectric thin film 40 described above, and thus, the impedance and the temperature properties of the dielectric thin film 40 are easily adjusted. The structure of the thin film capacitor is not limited to a structure illustrated in FIG. 2 insofar as the thin film capacitor includes the at least a pair of electrodes, and the dielectric thin film 40 that is disposed between the pair of electrodes.

### Examples of Third Invention

Hereinafter, the third invention will be described in more detail by examples and comparative examples, but the third invention is not limited to such examples.

### Example 51

<Preparation of Target>

A target that is a raw material of a dielectric thin film was prepared by the following solid-phase method.

Powders of each of bismuth oxide, sodium carbonate, strontium carbonate, and titanium oxide were mixed, and thus, a mixed powder was prepared. The powders of each of bismuth oxide, sodium carbonate, strontium carbonate, and titanium oxide were weighed such that the composition of the mixed powder was coincident with Chemical Formula 1A described below. That is, 1-x and x in Chemical Formula 1A were adjusted to values shown in Table 5 described below, and [Bi]/[E2] was a value shown in Table 5 described below. [Bi]/[E2] is defined as described above. [Bi]/[E2] is represented by {(1−x)×0.5}/x, on the basis of x in Chemical Formula 1A.

(1−x)Bi_{0.5}Na_{0.5}TiO₃-xSrTiO₃ (1A)

BNT described below indicates Bi_{0.5} Na_{0.5}TiO₃. ST described below indicates SrTiO₃.

The mixed powder described above and water were mixed for 20 hours by a ball mill, and thus, a slurry was prepared. The slurry was dried at 100° C., and thus, the mixed powder was collected. The mixed powder was molded by a press, and thus, a molded body was obtained. A molding pressure was 100 Pa. The temperature of the mixed powder in the molding was 25° C. A time for pressurizing the mixed powder was 3 minutes.

The molded body was burned in the air, and thus, a sintered body was obtained. A burning temperature was 1100° C. A burning time was 5 hours.

A disk-like target was prepared by processing the sintered body. The sintered body was processed by using a surface grinder and a cylindrical polishing machine. The diameter of the target was 80 mm, and the thickness of the target was 5 mm.

<Preparation of Dielectric Thin Film and Thin Film Capacitor>

A wafer consisting of Si single crystals was used as a substrate. The thickness of the substrate was 500 μm. The substrate was heated in oxidized gas, and thus, an insulating film consisting of SiO₂ was formed on the surface of the substrate. The thickness of the insulating film was adjusted to 500 nm.

A cohesive film consisting of Cr as formed on the surface of the substrate (the insulating film) by a sputtering method. The thickness of the cohesive film was adjusted to 20 nm. A lower electrode consisting of Pt was formed on the surface of the cohesive film by a sputtering method. The thickness of the lower electrode was adjusted to 100 nm.

A dielectric thin film was formed on the surface of the lower electrode by a radio-frequency sputtering method using the target described above. In the radio-frequency sputtering method, the substrate on which the insulating film, the cohesive film, and the lower electrode were laminated was provided in a vacuum chamber. The vacuum chamber was filled with mixed gas of Ar and O₂. An atmospheric pressure in the vacuum chamber was maintained at 1.0 Pa. The ratio (V/V2) of the volume V1 of Ar to the volume V2 of O₂ was 3/1. A radio-frequency voltage was 200 W. The temperature Tsub of the substrate 10 in the vacuum chamber was maintain at a temperature shown in Table 5 described below. The thickness of the dielectric thin film was adjusted to 300 nm.

The dielectric thin film was subjected to a rapid thermal annealing (RTA) treatment after the dielectric thin film was formed. In the RTA, the dielectric thin film was heated in the atmospheric air. In the RTA, the temperature of the dielectric thin film increased to the annealing temperature T at the predetermined temperature increase rate Vt, and then, the dielectric thin film 40 was continuously heated at the annealing temperature T. The dielectric thin film 40 was heated at the annealing temperature T, and then, the dielectric thin film 40 was cooled to a room temperature from the annealing temperature T at the temperature decrease rate Vt′. The temperature increase rate Vt of the RTA was 900° C./minute. The annealing temperature T was 900° C. An annealing time of the dielectric thin film was 1 minute. The temperature decrease rate Vt′ of the RTA was adjusted to a value shown in Table 5 described below.

After the RTA, an upper electrode consisting of Pt was formed on the surface of the dielectric thin film by a sputtering method. A circular upper electrode was formed by masking. The diameter of the upper electrode was adjusted to 200 μm. The thickness of the upper electrode was adjusted to 100 nm.

The dielectric thin film and a thin film capacitor of Example 51 were prepared by the method described above.

<Analysis of Dielectric Thin Film and Thin Film Capacitor>

[Analysis of Composition and Crystalline Structure of Dielectric Thin Film]

The composition of the dielectric thin film of Example 51 was analyzed by an X-ray fluorescence (XRF) analysis method. An analysis result indicated that the composition of the dielectric thin film was coincident with the composition represented by Chemical Formula 1A described above, and 1-x and x in Chemical Formula 1A were coincident with values shown in Table 5 described below. That is, the dielectric thin film of Example 51 was an oxide represented by Chemical Formula 1A described above.

An X-ray diffraction (XRD) pattern of the dielectric thin film of Example 51 was measured. In the XRD pattern, a CuKα ray was used as an incident X-ray. The XRD pattern was measured by using an X-ray diffraction device (SmartLab) manufactured by Rigaku Corporation. The XRD pattern indicated that the dielectric thin film contained an oxide having a perovskite structure.

The XRD pattern of the dielectric thin film of Example 51 included the peak Pexp having the diffraction angle 2θ of greater than or equal to 39.0° and less than or equal to 41.2°. The peak Pexp was separated into the first peak P1 and the second peak P2 by the curve fitting described above. That is, the measured peak Pexp was represented by the superposition of the first peak P1 and the second peak P2. The first peak P1 was approximated by the Voigt function f1. The second peak P2 was approximated by another Voigt function f2. The diffraction angle 2θ1 of the first peak P1 was approximately 40.13°, and was a diffraction angle peculiar to tetragonal crystals of the oxide described above. The diffraction angle 2θ₂ of the second peak P2 was approximately 40.26°, and was a diffraction angle peculiar to rhombohedral crystals of the oxide described above. The area S1 of the first peak P1 was calculated by the integration of the first peak P1. The area S2 of the second peak P2 was calculated by the integration of the second peak P2. S1/S2 of Example 51 is shown in Table 5 described below.

The analysis result described above indicated that the dielectric thin film of Example 51 contained the oxide represented by Chemical Formula 1A described above, the oxide had a perovskite structure, and the dielectric thin film contained tetragonal crystals and rhombohedral crystals.

[Evaluation of DC Bias Properties]

In a state where a direct-current electric field was not applied to the dielectric thin film, the electrostatic capacitance C1 of the thin film capacitor of Example 51 was measured. A digital LCR meter (4284A) manufactured by Hewlett-Packard Company was used as a measurement device of the electrostatic capacitance. All measurement conditions of the electrostatic capacitance C1 are as follows.

Measurement Temperature: 25° C.

Measurement Frequency: 1 kHz

Input Signal Level (Measurement Voltage): 1.0 Vrms

Intensity of Direct-current electric field (DC Bias): 0 V/μm

The relative permittivity εr1 of the dielectric thin film of Example 51 was calculated from the electrostatic capacitance C1, an effective area of the electrode (the area of the upper electrode), a distance between the electrodes, and the vacuum permittivity so. That is, the relative permittivity εr1 of the dielectric thin film in a state where the direct-current electric field was not applied to the dielectric thin film was calculated. εr1 of Example 51 is shown in Table 5 described below. There is no unit of the relative permittivity.

In a state where the direct-current electric field was applied to the dielectric thin film, the electrostatic capacitance C2 of the thin film capacitor of Example 51 was measured. The intensity of the direct-current electric field was 10 V/μm. All measurement conditions of the electrostatic capacitance C2 were identical to all measurement conditions of the electrostatic capacitance C1 except for the intensity of the direct-current electric field. The relative permittivity εr2 of the dielectric thin film of Example 51 was calculated from the electrostatic capacitance C2. That is, the relative permittivity εr2 of the dielectric thin film in a state where the direct-current electric field was applied to the dielectric thin film was calculated. A calculation method of εr2 was identical to a calculation method of εr1 except for the electrostatic capacitance. εr2 of Example 51 is shown in Table 5 described below. It is preferable that εr2 is greater than or equal to 600. It is more preferable that εr2 is greater than or equal to 630.

[Evaluation of Temperature Properties]

The thin film capacitor of Example 51 was provided in a thermostatic bath. The electrostatic capacitance of the thin film capacitor at each temperature was continuously measured while continuously changing the temperature of the thin film capacitor in the thermostatic bath to 85° C. from −55° C. All measurement conditions of the electrostatic capacitance at each of the temperatures are as follows.

Measurement Frequency: 1 kHz

Input Signal Level (Measurement Voltage): 1.0 Vrms

Intensity of Direct-current electric field (DC Bias): 0 V/m

The relative permittivity at each of the temperatures was calculated from the electrostatic capacitance at each of the temperatures. A calculation method of the relative permittivity at each of the temperatures was identical to the calculation method of εr1 except for the electrostatic capacitance. The change rate Δ249 r of the relative permittivity was calculated on the basis of the relative permittivity at each of the temperatures. Δ249 r is defined by Mathematical Expression a described below. The unit of Δεr is %. In Mathematical Expression a, εr(25° C.) is a relative permittivity at 25° C. εr(T) is a relative permittivity at which a difference with respect to εr(25° C.) is maximum in an absolute value, in all of the relative permittivities measured in the temperature range described above. Δεr of Example 51 is shown in Table 5 described below. It is preferable that Δεr is greater than or equal to −15% and less than or equal to 15%. It is more preferable that Δεr is greater than or equal to −10% and less than or equal to 10%.

Δεr=100×{εr(T)−εr(25° C.)}/εr(25° C.) (a)

### Examples 52 to 54

In the preparation of a target of each of Examples 52 to 54, 1-x and x in Chemical Formula 1A were adjusted to values shown in Table 5 described below, and [Bi]/[E2] was a value shown in Table 5 described below. A dielectric thin film and a thin film capacitor of each of Examples 52 to 54 were prepared by the same method as that in Example 51, except for the composition of the target.

The dielectric thin film and the thin film capacitor of each of Examples 52 to 54 were analyzed by the same method as that in Example 51. In any of Examples 52 to 54, the composition of the dielectric thin film was coincident with the composition represented by Chemical Formula 1A described above, and 1-x and x in Chemical Formula 1A were coincident with values shown in Table 5 described below. In any of Examples 52 to 54, the dielectric thin film contained the oxide represented by Chemical Formula 1A described above, the oxide had a perovskite structure, and the dielectric thin film contained tetragonal crystals and rhombohedral crystals. S1/S2, r1, r2, and Δ249 r of each of Examples 52 to 54 are shown in Table 5 described below.

In the XRD pattern of Example 51, the peak Pexp having the diffraction angle 2θ of greater than or equal to 39.0° and less than or equal to 41.2° is shown in FIG. 12. P1 and P2 of Example 51 are shown in FIG. 13. The peak (P1+P2) represented by the superposition of P1 and P2 of Example 51 is shown in FIG. 14. Pexp and P1+P2 of Example 51 are shown in FIG. 15.

### Comparative Example 51

The temperature Tsub of the substrate 10 in a radio-frequency sputtering method of Comparative Example 51 was maintained at a temperature shown in Table 5 described below. The temperature decrease rate Vt′ of the RTA in Comparative Example 51 was adjusted to a value shown in Table 5 described below. A dielectric thin film and a thin film capacitor of Comparative Example 51 were prepared by the same method as that in Example 52 except for such matters.

The dielectric thin film and the thin film capacitor of Comparative Example 51 were analyzed by the same method as that in Example 51. The composition of the dielectric thin film of Comparative Example 51 was coincident with the composition represented by Chemical Formula 1A described above, and 1-x and x in Chemical Formula 1A were coincident with values shown in Table 5 described below. An oxide of Comparative Example 51 had a perovskite structure. However, Si of Comparative Example 51 was zero, and S1/S2 of Comparative Example 51 was also zero. That is, the dielectric thin film of Comparative Example 51 contained rhombohedral crystals, but tetragonal crystals were not detected from the dielectric thin film of Comparative Example 51. εr1, εr2, and Δ249 r of Comparative Example 51 are shown in Table 5 described below.

### Examples 55 to 57

The temperature decrease rate Vt′ of the RTA of each of Examples 55 to 57 was adjusted to a value shown in Table 5 described below. A dielectric thin film and a thin film capacitor of each of Examples 55 to 57 were prepared by the same method as that in Example 52 except for the temperature decrease rate Vt′ of the RTA.

The dielectric thin film and the thin film capacitor of each of Examples 55 to 57 were analyzed by the same method as that in Example 51. In any of Examples 55 to 57, the composition of the dielectric thin film was coincident with the composition represented by Chemical Formula 1A described above, and 1-x and x in Chemical Formula 1A were coincident with values shown in Table 5 described below. In any of Examples 55 to 57, the dielectric thin film contained the oxide represented by Chemical Formula 1A described above, the oxide had a perovskite structure, and the dielectric thin film contain tetragonal crystals and rhombohedral crystals. S1/S2, εr1, εr2, and Ar of each of Examples 55 to 57 are shown in Table 5 described below.

### Comparative Example 52

The temperature decrease rate Vt′ of the RTA of Comparative Example 52 was adjusted to a value shown in Table 5 described below. A dielectric thin film and a thin film capacitor of Comparative Example 52 were prepared by the same method as that in Example 52 except for the temperature decrease rate Vt′ of the RTA.

The dielectric thin film and the thin film capacitor of Comparative Example 52 were analyzed by the same method as that in Example 51. The composition of the dielectric thin film of Comparative Example 52 was coincident with the composition represented by Chemical Formula 1A described above, and 1-x and x in Chemical Formula 1A were coincident with values shown in Table 5 described below. An oxide of Comparative Example 52 had a perovskite structure. However, S2 of Comparative Example 52 was zero, and S1/S2 of Comparative Example 52 was divergent to infinity. That is, the dielectric thin film of Comparative Example 52 contained tetragonal crystals, but rhombohedral crystals were not detected from the dielectric thin film of Comparative Example 52. εr1, εr2, and Δ249 r of Comparative Example 52 are shown in Table 5 described below.

### Example 61

A target of Example 61 was prepared by the following solid-phase method.

Powders of each of bismuth oxide, sodium carbonate, barium carbonate, and titanium oxide were mixed, and thus, a mixed powder was prepared. The powders of each of bismuth oxide, sodium carbonate, barium carbonate, and titanium oxide were weighed such that the composition of the mixed powder was coincident with Chemical Formula 1B described below. That is, 1-x and x in Chemical Formula 1B were adjusted to values shown in Table 6 described below, and [Bi]/[E2] was a value shown in Table 6 described below. [Bi]/[E2] is represented by {(1−x)×0.5}/x, on the basis of x in Chemical Formula 1B. BT described below indicates BaTiO₃.

(1−x)Bi_{0.5}Na_{0.5}TiO₃-xBaTiO₃ (1B)

A dielectric thin film and a thin film capacitor of Example 61 were prepared by the same method as that in Example 52 except for the composition of the target.

The dielectric thin film and the thin film capacitor of Example 61 were analyzed by the same method as that in Example 51. The composition of the dielectric thin film of Example 61 was coincident with the composition represented by Chemical Formula 1B described above, and 1-x and x in Chemical Formula 1B were coincident with values shown in Table 6 described below. The dielectric thin film of Example 61 contained the oxide represented by Chemical Formula 1B described above, the oxide had a perovskite structure, and the dielectric thin film contained tetragonal crystals and rhombohedral crystals. S1/S2, εr1, εr2, and Δεr of Example 61 are shown in Table 6 described below.

### Example 62

A target of Example 62 was prepared by the following solid-phase method.

Powders of each of bismuth oxide, sodium carbonate, calcium carbonate, and titanium oxide were mixed, and thus, a mixed powder was prepared. The powders of each of bismuth oxide, sodium carbonate, calcium carbonate, and titanium oxide were weighed such that the composition of the mixed powder was coincident with Chemical Formula 1C described below. That is, 1-x and x in Chemical Formula 1C were adjusted to values shown in Table 6 described below, and [Bi]/[E2] was a value shown in Table 6 described below. [Bi]/[E2] is represented by {(1−x)×0.5}/x, on the basis of x in Chemical Formula 1C. CT described below indicates CaTiO₃.

(1−x)Bi_{0.5}Na_{0.5}TiO₃-xCaTiO₃ (1C)

A dielectric thin film and a thin film capacitor of Example 62 were prepared by the same method as that in Example 52 except for the composition of the target.

The dielectric thin film and the thin film capacitor of Example 62 were analyzed by the same method as that in Example 51. The composition of the dielectric thin film of Example 62 was coincident with the composition represented by Chemical Formula 1C described above, and 1-x and x in Chemical Formula 1C were coincident with values shown in Table 6 described below. The dielectric thin film of Example 62 contained the oxide represented by Chemical Formula 1C described above, the oxide had a perovskite structure, and the dielectric thin film contained tetragonal crystals and rhombohedral crystals. S1/S2, εr1, εr2, and Δεr of Example 62 are shown in Table 6 described below.

### Example 63

A target of Example 63 was prepared by the following solid-phase method.

Powders of each of bismuth oxide, potassium carbonate, barium carbonate, and titanium oxide were mixed, and thus, a mixed powder was prepared. The powders of each of bismuth oxide, potassium carbonate, barium carbonate, and titanium oxide were weighed such that the composition of the mixed powder was coincident with Chemical Formula 1D described below. That is, 1-x and x in Chemical Formula 1D were adjusted to values shown in Table 6 described below, and [Bi]/[E2] was a value shown in Table 6 described below. [Bi]/[E2] is represented by {(1−x)×0.5}/x, on the basis of x in Chemical Formula 1D. BKT described below indicates Bi_{0.5}K_{0.5}TiO₃.

(1−x)Bi_{0.5}K_{0.5}TiO₃-xBaTiO₃ (1D)

A dielectric thin film and a thin film capacitor of Example 63 were prepared by the same method as that in Example 52 except for the composition of the target.

The dielectric thin film and the thin film capacitor of Example 63 were analyzed by the same method as that in Example 51. The composition of the dielectric thin film of Example 63 was coincident with the composition represented by Chemical Formula 1D described above, and 1-x and x in Chemical Formula 1D were coincident with values shown in Table 6 described below. The dielectric thin film of Example 63 contained the oxide represented by Chemical Formula 1D described above, the oxide had a perovskite structure, and the dielectric thin film contained tetragonal crystals and rhombohedral crystals. S1/S2, εr1, εr2, and Δεr of Example 63 are shown in Table 6 described below.

### Example 64

A target of Example 64 was prepared by the following solid-phase method.

Powders of each of bismuth oxide, potassium carbonate, strontium carbonate, and titanium oxide were mixed, and thus, a mixed powder was prepared. The powders of each of bismuth oxide, potassium carbonate, strontium carbonate, and titanium oxide were weighed such that the composition of the mixed powder was coincident with Chemical Formula 1E described below. That is, 1-x and x in Chemical Formula 1E were adjusted to values shown in Table 6 described below, [Bi]/[E2] was a value shown in Table 6 described below. [Bi]/[E2] is represented by {(1−x)×0.5}/x, on the basis of x in Chemical Formula 1E.

(1−x)Bi_{0.5}K_{0.5}TiO₃-xSrTiO₃ (1E)

A dielectric thin film and a thin film capacitor of Example 64 were prepared by the same method as that in Example 52 except for the composition of the target.

The dielectric thin film and the thin film capacitor of Example 64 were analyzed by the same method as that in Example 51. The composition of the dielectric thin film of Example 64 was coincident with the composition represented by Chemical Formula 1E described above, and 1-x and x in Chemical Formula 1E were coincident with values shown in Table 6 described below. The dielectric thin film of Example 64 contained the oxide represented by Chemical Formula 1E described above, the oxide had a perovskite structure, and the dielectric thin film contained tetragonal crystals and rhombohedral crystals. S1/S2, εr1, εr2, and Δ249 r of Example 64 are shown in Table 6 described below.

### Example 65

A target of Example 65 was prepared by the following solid-phase method.

Powders of each of bismuth oxide, potassium carbonate, calcium carbonate, and titanium oxide were mixed, and thus, a mixed powder was prepared. The powders of each of bismuth oxide, potassium carbonate, calcium carbonate, and titanium oxide were weighed such that the composition of the mixed powder was coincident with Chemical Formula 1F described below. That is, 1-x and x in Chemical Formula 1F were adjusted to values shown in Table 6 described below, and [Bi]/[E2] was a value shown in Table 6 described below. [Bi]/[E2] is represented by {(1−x)×0.5}/x, on the basis of x in Chemical Formula 1F.

(1−x)Bi_{0.5}K_{0.5}TiO₃-xCaTiO₃ (1F)

A dielectric thin film and a thin film capacitor of Example 65 were prepared by the same method as that in Example 52 except for the composition of the target.

The dielectric thin film and the thin film capacitor of Example 65 were analyzed by the same method as that in Example 51. The composition of the dielectric thin film of Example 65 was coincident with the composition represented by Chemical Formula 1F described above, and 1-x and x in Chemical Formula 1F were coincident with values shown in Table 6 described below. The dielectric thin film of Example 65 contained the oxide represented by Chemical Formula 1F described above, the oxide had a perovskite structure, and the dielectric thin film contained tetragonal crystals and rhombohedral crystals. S1/S2, εr1, εr2, and Δεr of Example 65 are shown in Table 6 described below.

TABLE 5

| | 1 − x | x | | | Tsub | Vt′ | ∈r 1 | ∈r 2 | Δ∈r |
|---|---|---|---|---|---|---|---|---|---|
| | (BNT) | (ST) | [Bi]/[E2] | S1/S2 | [° C.] | [° C./min] | (at 0 V/μm) | (at 10 V/μm) | [%] |
| Example 51 | 0.90 | 0.10 | 4.500 | 34.000 | 100 | 700 | 730 | 650 | −9 |
| Example 52 | 0.70 | 0.30 | 1.167 | 33.000 | 100 | 700 | 760 | 690 | −7 |
| Example 53 | 0.50 | 0.50 | 0.500 | 27.000 | 100 | 700 | 770 | 710 | −9 |
| Example 54 | 0.30 | 0.70 | 0.214 | 30.000 | 100 | 700 | 750 | 650 | −8 |
| Comparative | 0.70 | 0.30 | 1.167 | 0.000 | 300 | 100 | 750 | 660 | −17 |
| Example 51 | | | | | | | | | |
| Example 55 | 0.70 | 0.30 | 1.167 | 0.020 | 100 | 600 | 710 | 680 | −10 |
| Example 56 | 0.70 | 0.30 | 1.167 | 50.000 | 100 | 750 | 690 | 670 | −9 |
| Example 57 | 0.70 | 0.30 | 1.167 | 55.000 | 100 | 800 | 700 | 650 | −13 |
| Comparative | 0.70 | 0.30 | 1.167 | Infinity | 100 | 1000 | 730 | 640 | −18 |
| Example 52 | | | | | | | | | |

TABLE 6

| | | | | | Tsub | Vt′ | ∈r 1 | ∈r 2 | Δ∈r |
|---|---|---|---|---|---|---|---|---|---|
| | 1 − x | x | [Bi]/[E2] | S1/S2 | [° C.] | [° C./min] | (at 0 V/μm) | (at 10 V/μm) | [%] |
| Example 61 | (BNT) | (BT) | 1.167 | 30.000 | 100 | 700 | 710 | 690 | −8 |
| | 0.70 | 0.30 | | | | | | | |
| Example 62 | (BNT) | (CT) | 1.167 | 22.000 | 100 | 700 | 680 | 650 | −7 |
| | 0.70 | 0.30 | | | | | | | |
| Example 63 | (BKT) | (BT) | 1.167 | 20.000 | 100 | 700 | 690 | 660 | −9 |
| | 0.70 | 0.30 | | | | | | | |
| Example 64 | (BKT) | (ST) | 1.167 | 33.000 | 100 | 700 | 700 | 670 | −7 |
| | 0.70 | 0.30 | | | | | | | |
| Example 65 | (BKT) | (CT) | 1.167 | 10.000 | 100 | 700 | 680 | 650 | −9 |
| | 0.70 | 0.30 | | | | | | | |

### Industrial Applicability

The dielectric thin film according to the third invention, for example, is used in the thin film capacitor.

### REFERENCE SIGNS LIST OF FIGS. 10 TO 15

uc1: unit cell of tetragonal crystals, uc2: unit cell of rhombohedral crystals, Pexp: peak of diffraction X-ray having diffraction angle 2θ of greater than or equal to 39.0° and less than or equal to 41.2°, P1: first peak, P2: second peak.

<<Electronic Components According to Embodiments of Each of First Invention, Second Invention, and Third Invention>>

The dielectric thin films according to the embodiments of each of the first invention, the second invention, and the third invention can also be used in an electronic component such as an electronic circuit board and a piezoelectric element, in addition to the capacitor. Hereinafter, the “dielectric thin film” is synonymous with a “dielectric film”.

Electronic components comprising the dielectric thin films 40 according to the embodiments of each of the first invention, the second invention, and the third invention may be a piezoelectric element. The piezoelectric element, for example, may be a piezoelectric microphone, a harvester, an oscillator, a resonator, or an acoustic multilayer film. The piezoelectric element, for example, may be a piezoelectric actuator. The piezoelectric actuator, for example, may be used in a head assembly, a head stack assembly, or a hard disk drive. The piezoelectric actuator, for example, may be used in a printer head or an ink jet printer device. The piezoelectric actuator may be used in a piezoelectric switch. The piezoelectric element, for example, may be a piezoelectric transducer. The piezoelectric element, for example, may be a piezoelectric sensor. The piezoelectric sensor, for example, may be a gyro sensor, a pressure sensor, a pulse wave sensor, an ultrasonic sensor, or a shock sensor. The electronic component including the dielectric thin film 40 may be a pyroelectric element such as an infrared detector. Each of the electronic components described above may be a part or all of micro electro mechanical systems (MEMS).

<<Electronic Circuit Boards According to Embodiments of Each of First Invention, Second Invention, and Third Invention>>

Electronic circuit boards according to the embodiments of each of the first invention, the second invention, and the third invention identical to each other except for the composition or the crystalline structure of the dielectric film (the dielectric thin film). A structure and a manufacturing method of an electronic circuit board described below are common to all of the electronic circuit boards according to the embodiments of each of the first invention, the second invention, and the third invention.

The electronic circuit board may comprise the dielectric thin film according to the first invention, the second invention, or the third invention. The electronic circuit board may comprise the electronic component including the dielectric thin film. For example, the electronic circuit board may comprise the thin film capacitor described above, as an electronic component. The electronic component such as the thin film capacitor may be provided on the surface of the electronic circuit board. The electronic component such as the thin film capacitor may be embedded in the electronic circuit board. An example of the electronic circuit board is illustrated in FIG. 4A and FIG. 4B. An electronic circuit board 90 may comprise an epoxy-based resin substrate 92, a resin layer 93 covering the epoxy-based resin substrate 92, a thin film capacitor 91 provided on the resin layer 93, an insulating covering layer 94 covering the resin layer 93 and the thin film capacitor 91, an electronic component 95 provided on the insulating covering layer 94, and a plurality of metal wirings 96. At least a part of the metal wirings 96 may be led out to the surface of the epoxy-based resin substrate 92 or the insulating covering layer 94. At least a part of the metal wirings 96 may be connected to a taking-out electrode of the thin film capacitor 91 or the electronic component 95. At least a part of the metal wirings 96 may penetrate through the electronic circuit board 90 in a direction towards a rear surface from the surface of the electronic circuit board 90.

As illustrated in FIG. 4B, the thin film capacitor 91 may comprise the lower electrode 30, the dielectric thin film 40 provided on the surface of the lower electrode 30, the upper electrode 50 provided on a part of the upper surface of the dielectric thin film 40, a through electrode 52 penetrating through the other portion of the dielectric thin film 40 to be directly provided on the surface of the lower electrode 30, an insulating resin layer 58 covering the upper electrode 50, the dielectric thin film 40, and the through electrode 52, a taking-out electrode 54 penetrating through the insulating resin layer 58 to be directly provided on the surface of the through electrode 52, and a taking-out electrode 56 penetrating through the insulating resin layer 58 to be directly provided on the surface of the upper electrode 50.

The electronic circuit board 90 may be manufactured by the following procedure. First, the surface of the epoxy-based resin substrate 92 is covered with an uncured resin layer. The uncured resin layer is a precursor of the resin layer 93. The thin film capacitor 91 is provided on the surface of the uncured resin layer such that a base electrode of the thin film capacitor 91 faces the uncured resin layer. The uncured resin layer and the thin film capacitor 91 are covered with the insulating covering layer 94, and thus, the thin film capacitor 91 is interposed between the epoxy-based resin substrate 92 and the insulating covering layer 94. The uncured resin layer is thermally cured, and thus, the resin layer 93 is formed. The insulating covering layer 94 is pressure-bonded to the epoxy-based resin substrate 92, the thin film capacitor 91, and the resin layer 93 by a thermal press. A plurality of through holes penetrating through such a laminated substrate are formed. The metal wirings 96 are formed in each of the through holes. The metal wirings 96 are formed, and then, the electronic component 95 is provided on the surface of the insulating covering layer 94. By the method described above, the electronic circuit board 90 embedded in the thin film capacitor 91 is obtained. Each of the metal wirings 96 may consist of a conductor such as Cu. The uncured resin layer may be a thermosetting resin (for example, an epoxy resin or the like) of a stage B. The thermosetting resin of the stage B is not completely cured at a room temperature, but is completely cured by heating. The insulating covering layer 94 may contain an epoxy-based resin, a polytetrafluoroethylene-based resin, a polyimide-based resin, or the like.

What is claimed is:

1. A dielectric film, containing:
(1) Bi and Ti;
(2) at least one element E1 selected from the group consisting of Na and K; and
(3) at least one element E2 selected from the group consisting of Ba, Sr, and Ca,
wherein the dielectric film has
a main phase containing an oxide that contains Bi, Ti, the element E1, and the element E2 and has a perovskite structure, and
a subphase that contains Bi and has an oxygen concentration lower than that of the main phase, and
in a sectional surface of the dielectric film, a ratio RS of an area of the subphase to a sum of an area of the main phase and the area of the subphase satisfies the following expression:
0.03≤RS≤0.3.

2. The dielectric film according to claim 1,
wherein Total Number of Atoms of Bi and Element E1:Total Number of Atoms of Element E2 is 30:70 to 90:10.

3. The dielectric film according to claim 1,
wherein in the oxide, a ratio of the number of atoms of the element E1 to the number of atoms of Bi is 0.9 to 1.1.

4. The dielectric film according to claim 1,
wherein in the oxide, a ratio of the number of atoms of Ti to the total number of atoms of Bi, the element E1, and the element E2 is 0.9 to 1.1.

5. An electronic component, comprising:
the dielectric film according to claim 1.

6. The electronic component according to claim 5, further comprising:
an electrode,
wherein the dielectric film is in contact with the electrode.

7. A thin film capacitor, comprising:
the dielectric film according to claim 1.

8. An electronic circuit board, comprising:
the dielectric film according to claim 1.

9. An electronic circuit board, comprising:
the electronic component according to claim 5.

10. An electronic circuit board, comprising:
the thin film capacitor according to claim 7.

11. A dielectric thin film, containing:
an oxide having a perovskite structure,
wherein the oxide contains Bi, an element E1, an element E2, and Ti,
the element E1 is at least one element selected from the group consisting of Na and K,
the element E2 is at least one element selected from the group consisting of Ca, Sr, and Ba, and
the oxide contains twin crystals.

12. The dielectric thin film according to claim 11,
wherein a content of Bi in the dielectric thin film is represented by [Bi] mol %,
a sum of contents of the elements E2 in the dielectric thin film is represented by [E2] mol %, and
[Bi]/[E2] is greater than or equal to 0.214 and less than or equal to 4.500.

13. An electronic component, comprising:
the dielectric thin film according to claim 11.

14. A thin film capacitor, comprising:
the dielectric thin film according to claim 11.

15. An electronic circuit board, comprising:
the dielectric thin film according to claim 11.

16. An electronic circuit board, comprising:
the electronic component according to claim 13.

17. An electronic circuit board, comprising:
the thin film capacitor according to claim 14.

18. A dielectric thin film, containing:
an oxide having a perovskite structure,
wherein the oxide contains Bi, an element E1, an element E2, and Ti,
the element E1 is at least one element selected from the group consisting of Na and K,
the element E2 is at least one element selected from the group consisting of Ca, Sr, and Ba, and
the dielectric thin film contains tetragonal crystals of the oxide and rhombohedral crystals of the oxide.

19. A dielectric thin film, containing:
an oxide having a perovskite structure,
wherein the oxide contains Bi, an element E1, an element E2, and Ti,
the element E1 is at least one element selected from the group consisting of Na and K,
the element E2 is at least one element selected from the group consisting of Ca, Sr, and Ba,
an X-ray diffraction pattern of the dielectric thin film is measured by using a CuKα ray as an incident X-ray,
the X-ray diffraction pattern includes a peak having a diffraction angle 2θ of greater than or equal to 39.0° and less than or equal to 41.2°,
the peak having the diffraction angle 2θ of greater than or equal to 39.0° and less than or equal to 41.2° is represented by superposition of a first peak and a second peak,
a diffraction angle 2θ₁ of the first peak is less than a diffraction angle 2θ₂ of the second peak,
S1 is an area of the first peak,
S2 is an area of the second peak, and
S1/S2 is greater than or equal to 0.02 and less than or equal to 55.

20. The dielectric thin film according to claim 19, containing:
tetragonal crystals of the oxide and rhombohedral crystals of the oxide,
wherein the first peak is derived from the tetragonal crystals of the oxide, and
the second peak is derived from the rhombohedral crystals of the oxide.

21. The dielectric thin film according to claim 18,
wherein a content of Bi in the dielectric thin film is represented by [Bi] mol %,
a sum of contents of the elements E2 in the dielectric thin film is represented by [E2] mol %, and
[Bi]/[E2] is greater than or equal to 0.214 and less than or equal to 4.500.

22. An electronic component, comprising:
the dielectric thin film according to claim 18.

23. A thin film capacitor, comprising:
the dielectric thin film according to claim 18.

24. An electronic circuit board, comprising:
the dielectric thin film according to claim 18.

25. An electronic circuit board, comprising:
the electronic component according to claim 22.

26. An electronic circuit board, comprising:
the thin film capacitor according to claim 23.
